(19) United States
(12) Patent Application Publication
(10) Pub. No.: US 2025/0171591 A1
(43) Pub. Date: May 29, 2025

(54) NEW POLYMERS AND USES THEREOF

(71) Applicant: FLINDERS UNIVERSITY, Beford Park (AU)

(72) Inventors: Justin Mark CHALKER, Bedford Park (AU); Samuel TONKIN, Beford Park (AU)

(21) Appl. No.: 18/836,670

(22) PCT Filed: Feb. 7, 2023
(86) PCT No.: PCT/AU2023/050077

§ 371 Date: Aug. 7, 2024

(30) Foreign Application Priority Data
Feb. 11, 2022 (AU) 2022900289

(51) Int. Cl. C08G 75/14; B01J 10/00

(52) U.S. Cl. CPC C08G 75/14; B01J 10/005

(57) ABSTRACT

A cured polymer prepared by reacting: low molecular weight, rigid, organic monomers, with molten elemental sulfur, followed by curing the prepared polymer, wherein the cured polymer is transparent to mid-wave infrared (MWIR) light and long-wave infrared (LWIR) light.

### PRIORITY DOCUMENT

The present application claims priority from Australian Provisional Patent Application No. 2022900289 titled “NEW POLYMERS AND USES THEREOF” and filed on 11 Feb. 2022, the content of which is hereby incorporated by reference in its entirety.

### TECHNICAL FIELD

The present disclosure relates to sulfur-containing infrared (IR)-transmissible polymers, and to methods of, and an apparatus for, producing the polymers. The present disclosure also relates to the use of the polymers in components for IR imaging applications.

### BACKGROUND

Infrared (IR) imaging is a critical technology in a number of sectors. For example, IR imaging is the basis for thermal imaging in surveillance systems, with applications in defence, wildlife monitoring, driver assistance systems, and autonomous vehicles. IR imaging is also useful in medical diagnosis as many diseased tissues have a higher temperature than healthy tissue, and also facilitates the monitoring of electrical equipment and machines, where areas of elevated temperature may be indicative of impending failure. IR optics and associated equipment are also critical in astronomy and space missions.

One limitation of current IR imaging technology is the cost of lenses, windows, and related components that are transparent to IR radiation—expensive semiconductors (such as germanium) and chalcogenide glasses (such as zinc selenide) are standard materials for IR lenses and windows. Additionally, these semiconductor materials are often manufactured using time-consuming processes (such as Computerised Numerical Control (CNC) milling technology) which are not ideal for high-throughput production. In the case of chalcogenide glasses, another shortcoming is that the elements they contain are often toxic (e.g. arsenic and selenium) or low in abundance (e.g. germanium). Further, to produce high purity chalcogenide glass, high temperatures and energy intensive processes are often required. Another significant drawback with regard to the use of these materials is that, once damaged, they cannot be repaired and need to be replaced, which further adds to the cost.

Polymer materials are attractive for their processability (for instance by injection moulding or melt processing), but their refractive indices and IR transparency are typically too low for IR imaging applications.

There is therefore a need to identify alternative IR-transmissible materials for use in IR imaging applications, which materials are inexpensive and simple to manufacture.

### SUMMARY

The present inventors have developed new polymers for use in IR imaging applications. The inventors have surprisingly found that the copolymerisation of elemental sulfur with particular monomers can provide polymers that have the IR transparency and high refractive indices required of components used in IR imaging, particularly thermal imaging. In addition, by utilising simple, widely-available starting materials, the inventors have developed a polymeric material that is inexpensive and uncomplicated to produce.

According to a first aspect, there is provided a cured polymer prepared by reacting:
low molecular weight, rigid, organic monomers, with
molten elemental sulfur,
followed by curing the prepared polymer,
wherein the cured polymer is transparent to mid-wave infrared (MWIR) light and long-wave infrared (LWIR) light.

In one form, the weight ratio of the monomers to the elemental sulfur used in the reaction is from about 1:1 to about 1:10. The weight ratio of the monomers to the elemental sulfur used in the reaction may be about 1:1 to about 1:4.

In one form, the cured polymer has a sulfur content of between about 40% w/w and about 90% w/w. The sulfur content may be between about 50% w/w and about 70% w/w.

In one form, the cured polymer has a monomer content of between about 60% w/w and about 10% w/w. The monomer content may be between about 50% w/w and about 30% w/w.

In one form, the monomers are selected from the group consisting of ethene, acetylene, tetrafluoroethylene, tetrachloroethylene, propene, butadiene, carbondisulfide, cyclopentadiene, cyclopropene, cyclobutene, cyclobutadiene, and episulfide. The monomers may be unsaturated. The monomers may be selected from the group consisting of ethene, acetylene, tetrafluoroethylene, tetrachloroethylene, propene, butadiene, carbondisulfide, cyclopentadiene, cyclopropene, cyclobutene and cyclobutadiene.

In one form, an additional co-monomer is also used in the reacting step. The additional co-monomer is preferably a low molecular weight, rigid, organic monomer. The additional co-monomer may be selected from the group consisting of ethene, acetylene, tetrafluoroethylene, tetrachloroethylene, propene, butadiene, carbondisulfide, cyclopentadiene, dicyclopentadiene, norbornene, norbornadiene, cyclopropene, cyclobutene, cyclobutadiene, and episulfide. The additional co-monomer may be unsaturated. The additional co-monomer may be selected from the group consisting of ethene, acetylene, tetrafluoroethylene, tetrachloroethylene, propene, butadiene, carbondisulfide, cyclopentadiene, dicyclopentadiene, norbornene, norbornadiene, cyclopropene, cyclobutene and cyclobutadiene. The additional co-monomer may be used in the reacting step in a weight ratio of from about 1:10 to about 1:1 sulfur to co-monomer.

In one form, an additive is also used in the reacting step. The additive may be selected from selenium, tetravinyltin, dicyclopentadiene, norbornadiene and norbornene.

In one form, the molten elemental sulfur is heated at a temperature of between about 140° C. and about 185° C.

The polymer may be cured by heating. The polymer may be cured in a mould.

In one form, the cured polymer may be subjected to hot pressing. The hot pressing may be performed at a temperature of from about 100° C. to about 140° C.

In one form, the cured polymer has a % transmittance of MWIR light of greater than or equal to about 50% at a thickness of about 1 mm.

In one form, the cured polymer has a % transmittance of LWIR light of greater than or equal to about 8% at a thickness of about 1 mm.

In one form, the cured polymer has a % transmittance of visible light of 0% at a thickness of about 1 mm.

According to another aspect, the present invention relates to a cured polymer having a sulfur content of between about 40% w/w and about 90% w/w and a monomer content of between about 60% w/w and about 10% w/w, wherein the monomer is a low molecular weight, rigid, organic monomer, and the polymer is transparent to mid-wave infrared (MWIR) light and long-wave infrared (LWIR) light.

The sulfur content may be between about 50% w/w and about 70% w/w.

The monomer content may be between about 50% w/w and about 30% w/w.

In one form, the monomer is selected from the group consisting of ethene, acetylene, tetrafluoroethylene, tetrachloroethylene, propene, butadiene, carbondisulfide, cyclopentadiene, cyclopropene, cyclobutene, cyclobutadiene, and episulfide. The monomer may be unsaturated. The monomer may be selected from the group consisting of ethene, acetylene, tetrafluoroethylene, tetrachloroethylene, propene, butadiene, carbondisulfide, cyclopentadiene, cyclopropene, cyclobutene and cyclobutadiene.

In one form, an additional co-monomer is also present. The additional co-monomer is preferably a low molecular weight, rigid, organic monomer. The additional co-monomer may be selected from the group consisting of ethene, acetylene, tetrafluoroethylene, tetrachloroethylene, propene, butadiene, carbondisulfide, cyclopentadiene, dicyclopentadiene, norbornene, norbornadiene, cyclopropene, cyclobutene, cyclobutadiene, and episulfide. The additional co-monomer may be unsaturated. The additional co-monomer may be selected from the group consisting of ethene, acetylene, tetrafluoroethylene, tetrachloroethylene, propene, butadiene, carbondisulfide, cyclopentadiene, dicyclopentadiene, norbornene, norbornadiene, cyclopropene, cyclobutene and cyclobutadiene. The additional co-monomer may be present in a weight ratio of from about 1:10 to about 1:1 sulfur to co-monomer.

In one form, an additive is also present. The additive may be selected from selenium, tetravinyltin, dicyclopentadiene, norbornadiene and norbornene.

In one form, the cured polymer has a % transmittance of MWIR light of greater than or equal to about 50% at a thickness of about 1 mm.

In one form, the cured polymer has a % transmittance of LWIR light of greater than or equal to about 8% at a thickness of about 1 mm.

In one form, the cured polymer has a % transmittance of visible light of about 0% at a thickness of about 1 mm.

According to a third aspect, there is provided a component for use in infrared (IR) imaging applications, the component composed of, or comprising, the cured polymer of the present invention, as described herein.

In one form, the component is a sheet, window, sample cell, waveguide or filter. The component may have a thickness equal to, or less than, about 2 mm. The component may have a thickness equal to, or less than, about 1 mm.

In one form, the component is a lens.

In one form, the component has a % transmittance of MWIR light of greater than or equal to 50% at a thickness of about 1 mm.

In one form, the component has a % transmittance of LWIR light of greater than or equal to 8% at a thickness of about 1 mm.

In one form, the component has a % transmittance of visible light of about 0% at a thickness of about 1 mm.

According to a fourth aspect, there is provided a method of producing a cured polymer that is transparent to mid-wave infrared (MWIR) light and long-wave infrared (LWIR) light, the method comprising:
a) providing molten elemental sulfur;
b) adding, to the molten elemental sulfur, low molecular weight, rigid, organic monomers in aliquots to produce a mixture, wherein the aliquots are added such that the sulfur does not crystallise;
c) optionally further heating the mixture;
thereby preparing a polymer, and
d) curing the prepared polymer.

In one form, the molten elemental sulfur is heated at a temperature of between about 140° C. and about 185° C.

In one form, the monomers are added to the molten elemental sulfur in a total amount of from about 1:1 to about 1:4 (weight ratio) of monomers to elemental sulfur.

In one form, the monomers are in a gaseous state. The monomers may be introduced directly into the molten elemental sulfur.

In one form, the monomers are selected from the group consisting of ethene, acetylene, tetrafluoroethylene, tetrachloroethylene, propene, butadiene, carbondisulfide, cyclopentadiene, cyclopropene, cyclobutene, cyclobutadiene, and episulfide. The monomers may be unsaturated. The monomers may be selected from the group consisting of ethene, acetylene, tetrafluoroethylene, tetrachloroethylene, propene, butadiene, carbondisulfide, cyclopentadiene, cyclopropene, cyclobutene and cyclobutadiene.

In one form, an additional co-monomer is also added to the molten elemental sulfur. The additional co-monomer is preferably a low molecular weight, rigid, organic monomer. The additional co-monomer may be selected from the group consisting of ethene, acetylene, tetrafluoroethylene, tetrachloroethylene, propene, butadiene, carbondisulfide, cyclopentadiene, dicyclopentadiene, norbornene, norbornadiene, cyclopropene, cyclobutene, cyclobutadiene, and episulfide. The additional co-monomer may be unsaturated. The additional co-monomer may be selected from the group consisting of ethene, acetylene, tetrafluoroethylene, tetrachloroethylene, propene, butadiene, carbondisulfide, cyclopentadiene, dicyclopentadiene, norbornene, norbornadiene, cyclopropene, cyclobutene and cyclobutadiene. The additional co-monomer may be added to the elemental sulfur in a total amount of from about 1:10 to about 1:1 (weight ratio) of elemental sulfur to co-monomer. The additional co-monomer may be added as a mixture with the monomers. When a co-monomer is also added to the molten elemental sulfur, the molten elemental sulfur may be heated at a temperature of between about 160° C. and about 185° C. The additional co-monomer may be in a gaseous state.

In one form, an additive is also added to the molten elemental sulfur. The additive may be selected from selenium, tetravinyltin, dicyclopentadiene, norbornadiene and norbornene. The additive may be added as a mixture with the monomer and/or co-monomer.

According to a fifth aspect, there is provided an apparatus for polymerising molten elemental sulfur with monomers in a gaseous state, the apparatus comprising a first sealed vessel, the first sealed vessel comprising:
molten elemental sulfur;
a port through which monomers in a gaseous state are introduced into the first sealed vessel, such that the monomers reside in the headspace above the molten elemental sulfur;
an outlet through which the monomers are introduced directly into the molten elemental sulfur;
an inlet in fluid communication with both the outlet and with the headspace above the molten elemental sulfur,
wherein the monomers are continuously circulated from the headspace through the inlet and out of the outlet into the molten elemental sulfur such that the monomers undergo a polymerisation reaction with the molten elemental sulfur.

In one form, the apparatus comprises a second sealed vessel, wherein the second sealed vessel is used to generate the monomers in a gaseous state, and comprises a first port by means of which the second sealed vessel is connected to the port of the first vessel such that the monomers generated in the second vessel pass into the first vessel. The second vessel may comprise a second port by means of which the second sealed vessel is connected to a condenser.

In one form, the monomers have a boiling point above room temperature and below the melting point of molten elemental sulfur. The monomers are preferably low molecular weight, rigid, organic monomers. The monomers may be selected from norbornadiene, norbornene, carbondisulfide, butadiene, episulfide, cyclopropene, and cyclobutene.

### BRIEF DESCRIPTION OF DRAWINGS

Embodiments of the present disclosure will be discussed with reference to the accompanying drawings wherein:

FIG. 1 depicts the stages of the preparation of a mould for use with a polymer of the present invention: (a) 3D printed mould negative with glass slides; (b) silicone mould in negative; (c) final silicone mould.

FIG. 2 is an image of a polymer window of 1 mm thickness made from sulfur and cyclopentadiene according to Example 2.

FIG. 3 is a UV-Vis-NIR transmittance spectrum for the polymer film produced in Example 2.

FIG. 4: (a) IR spectrum (over the range 2 μm to 20 μm) of the 1 mm polymer film produced in Example 2; (b) IR spectrum (over the range 5000 cm⁻¹ to 0 cm⁻¹) of a polymer film produced in accordance with Example 2 but having a thickness of 0.2 mm.

FIG. 5 is a GC-MS chromatogram of the polymer film produced in Example 2.

FIG. 6 depicts three images of a human hand: (a) an optical image of a human hand; (b) LWIR thermal image of the same human hand obtained with an FLIR E6 camera; (c) LWIR thermal image of the same human hand obtained through the polymer film produced in Example 2.

FIG. 7 shows the results of a Simultaneous Thermal Analysis (STA) of the polymer produced and cured according to Example 2: (a) STA plot of sulfur as a control; (b) STA plot of polymer with a composition of 67% sulfur and 33% cyclopentadiene.

FIG. 8 is a Differential Scanning Calorimetry (DSC) plot of polymer prepared with 67% sulfur and 33% cyclopentadiene showing two cycles from −50° C. to 130° C. under nitrogen. The onset, inflection and end of baseline shifts have been labelled to determine T_{g}.

FIG. 9 shows the average IR transmission for the polymer produced in Example 2 in a range of thicknesses: (a) average transmission in the MWIR region (3 μm to 5 μm); (b) average transmission in the LWIR region (7 μm to 14 μm).

FIG. 10 contains images of the hot press used, and the polymer sheet produced, in Example 3: (a) base piece, (b) outer piece and (c) top piece of press; (d) assembled press; (e) assembled press in hot press; (f) polymer sheet; (g) side view of polymer sheet.

FIG. 11: (a-d) images of IR camera casing and polymer sheet produced in Example 3; (e) optical image of dog, and LWIR image with FLIR E6 camera both (f) without polymer, and (g) through the polymer sheet prepared according to Example 3; (h) optical image of chickens in low light conditions, and LWIR image with FLIR E6 camera both (i) without polymer, and (j) through the polymer sheet prepared according to Example 3.

FIG. 12 shows the top and side views of two lenses composed of a polymer of the present invention: (a) and (b) a plano convex lens; (c) and (d) a plano concave lens; and, (e) and (f) a Fresnel lens.

FIG. 13 contains images of: (a) camera set up for lens testing; and LWIR images of hot oil bath (b) with no lens, (c) with a magnifying lens, and (d) reducing lens.

FIG. 14 shows the IR transmittance spectra of 1 mm thick, cured polymer samples made from sulfur and cyclopentadiene in different ratios: (a) polymer made from 50% sulfur and 50% cyclopentadiene; (b) polymer made from 67% sulfur and 33% cyclopentadiene; (c) polymer made from 75% sulfur and 25% cyclopentadiene; (d) polymer made from 80% sulfur and 20% cyclopentadiene.

FIG. 15 shows the change in glass transition temperature (T_{g}) as the amount of dicyclopentadiene (DCPD) is increased.

FIG. 16: (a) average LWIR transmission for 1 mm thick, cured polymer samples with 50% sulfur and 50% made up of varying proportions of cyclopentadiene (CPD) and dicyclopentadiene (DCPD); (b) average MWIR transmission for 1 mm thick polymer samples with 50% sulfur and 50% made up of CPD and DCPD. In both (a) and (b), the composition of the polymer is labelled based on the proportion of DCPD.

FIG. 17 shows STA plots for sulfur and cured polymer samples: (a) sulfur (control); (b) polymer made with 50% sulfur/50% CPD; (c) polymer made with 50% sulfur/25% CPD/25% DCPD; (d) polymer made with 50% sulfur/50% DCPD.

FIG. 18: (a) TGA plots of cured polymers with 50% sulfur and 50% made up of DCPD and CPD in different ratios, by mass (polymer composition is labelled by percent DCPD in the feedstock); (b) the mass of polymer remaining after heating to 800° C. under nitrogen for the same polymer samples from (a).

FIGS. 19A and 19B show IR spectra of various sulfur-CPD-DCPD polymer compositions of 1 mm thickness: (a) 50% sulfur/50% CPD/0% DCPD; (b) 50% sulfur/45% CPD/5% DCPD; (c) 50% sulfur/40% CPD/10% DCPD; (d) 50% sulfur/30% CPD/20% DCPD; (e) 50% sulfur/25% CPD/25% DCPD; (f) 50% sulfur/20% CPD/30% DCPD; (g) 50% sulfur/10% CPD/40% DCPD; (h) 50% sulfur/0% CPD/50% DCPD.

FIGS. 20A and 20B show IR spectra of various sulfur-CPD-DCPD polymer compositions of a thickness of about 0.2 mm: (a) 50% sulfur/50% CPD/0% DCPD; (b) 50% sulfur/45% CPD/5% DCPD; (c) 50% sulfur/40% CPD/10% DCPD; (d) 50% sulfur/30% CPD/20% DCPD; (e) 50% sulfur/25% CPD/25% DCPD; (f) 50% sulfur/20% CPD/30% DCPD; (g) 50% sulfur/10% CPD/40% DCPD; (h) 50% sulfur/0% CPD/50% DCPD.

FIG. 21 shows GC-MS spectra of reduced products from various sulfur-CPD-DCPD polymer compositions: (a) 50% sulfur/50% CPD/0% DCPD; (b) 50% sulfur/45% CPD/5% DCPD; (c) 50% sulfur/40% CPD/10% DCPD; (d) 50% sulfur/30% CPD/20% DCPD; (e) 50% sulfur/20% CPD/30% DCPD; (f) 50% sulfur/0% CPD/50% DCPD.

FIG. 22 shows a reactor design for polymerising molten sulfur with monomers that are in a gaseous state.

FIG. 23 is an IR spectrum of a 1 mm thick polymer sheet made from the polymerisation of sulfur and cyclopentadiene gas, and cured.

FIG. 24 shows the visible and near-IR transmission spectrum for a 1 mm thick, cured polymer sample made by the reaction of molten sulfur and cyclopentadiene gas.

FIG. 25 shows images of sheets composed of: (a) and (b) a polymer of the present invention (produced according to Example 2); (c) and (d), and (e) and (f) 1,3-diisopropenylbenzene (DIB)-containing prior art polymers.

FIG. 26: (a) photo of a human hand behind a sheet composed of a cured polymer of the present invention and DIB polymers with the same mass ratio and molar ratio (the cyclopentadiene polymer is the left most sample, the DIB polymer with the same mass ratio is in the middle position and the DIB polymer with the same molar ratio is the right most sample); (b) LWIR image from 7.5 μm to 13 μm of the samples from (a); (c) gloved hand imaged through a polymer of the present invention; (d) gloved hand imaged through sheet composed of 67% sulfur/33% DIB polymer; (e) gloved hand imaged through sheet composed of 44% sulfur/56% DIB polymer.

FIG. 27 shows IR spectra (MWIR and LWIR regions highlighted) for a sheet composed of a cured polymer of the present invention, and two sheets composed of prior art DIB polymers.

FIG. 28 shows visible and NIR spectra for a sheet composed of a cured polymer of the present invention and two sheets composed of prior art DIB polymers.

FIG. 29 shows the FTIR spectra for a sample composed of a polymer of the present invention, as well as samples composed of four different prior art monomers: the 1 mm S-r-CPD sample was prepared using a ratio of 67% sulfur and 33% cyclopentadiene; the 1 mm S-r-DIB sample was prepared with 67% sulfur and 33% 1,2-diisopropenylbenzene; the 1 mm S-r-TIB sample was prepared with 70% sulfur and 30% 1,3,5-triisopropenylbenzene; the 1 mm S-r-NBD2 sample was prepared with 70% sulfur and 30% norbornadiene 2; the 1.55 mm S-r-TVSn sample was prepared with 70% sulfur and 30% tetravinyltin.

FIG. 30 shows the same FTIR spectra as those given in FIG. 29 but the LWIR region has been expanded.

FIG. 31 shows the FTIR spectra for a sample composed of a polymer of the present invention, as well as samples composed of two different prior art monomers, with a thickness of 200 μm: the S-r-CPD sample was prepared using a ratio of 67% sulfur and 33% cyclopentadiene; the S-r-PSN 76 sample (“PSN76”) was prepared with 76% sulfur and 24% p-diiodobenzene; and the S-r-BMETP-TA (“BMETP-TA) sample was produced through a thiolene reaction with BMETP.

FIG. 32 shows the same FTIR spectra as those given in FIG. 31 but the LWIR region has been expanded.

FIG. 33 shows the average transmission over the MWIR region for various polymers: S-r-CPD, S-r-DIB, S-r-TIB, S-r-NBD2 (“S-NBD2”) and S-r-TVSn.

FIG. 34 shows the average transmission over the LWIR region for various polymers: S-r-CPD, S-r-DIB, S-r-TIB, S-r-NBD2 (“S-NBD2”) and S-r-TVSn.

FIG. 35 shows the average transmission over the MWIR region for various polymers: S-r-CPD, S-r-PSN 76 (“PSN76”), and S-r-BMETP-TA (“BMETP-TA”).

FIG. 36 shows the average transmission over the LWIR region for various polymers: S-r-CPD, S-r-PSN 76 (“PSN76”), and S-r-BMETP-TA (“BMETP-TA”).

### DESCRIPTION OF EMBODIMENTS

Reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of a, b, or c” is intended to cover: a, b, c, a-b, a-c, b-c, and a-b-c.

The singular forms “a”, “an” and “the” include the plural unless the context clearly dictates otherwise.

Ranges may be expressed herein as from “about” one particular value and/or to “about” another particular value. When such a range is expressed, another embodiment includes from the one particular value and/or to the other particular value. Similarly, when values are expressed as approximations by use of the antecedent “about”, it will be understood that the particular value forms another embodiment. It will be further understood that the endpoints of each of the ranges are significant both in relation to the other endpoint, and independently of the other endpoint.

When ranges are used herein in the absence of the term “about”, they are also intended to include the particular value at either end of the range as well as the intervening values, and it will be understood that each particular value forms another embodiment.

“Optional” or “optionally” means that the subsequently described event or circumstance may or may not occur, and that the description includes instances where said event or circumstance occurs and instances where it does not.

As discussed above, the present inventors have developed new polymer materials for IR imaging applications, by copolymerising molten elemental sulfur with particular types of monomers. Accordingly, in one aspect, the present invention relates to a cured polymer prepared by reacting:
low molecular weight, rigid, organic monomers, with
molten elemental sulfur,
followed by curing the prepared polymer,
wherein the polymer is transparent to mid-wave infrared (MWIR) light and long-wave infrared (LWIR) light.

The present inventors have found that monomers which are small (i.e. have a low molecular weight) and that are rigid are preferred starting materials for preparing the polymers of the present invention. The term “rigid” as used throughout the specification refers to compounds in which the bonds between the atoms that make up the compounds have few vibrational degrees of freedom, thereby minimising the absorption of IR light and in particular, MWIR light and LWIR light. Suitable monomers for use in preparing the polymers of the present invention include those selected from the group consisting of ethene, acetylene, tetrafluoroethylene, tetrachloroethylene, propene, butadiene, carbondisulfide, cyclopentadiene, cyclopropene, cyclobutene, cyclobutadiene, and episulfide. Preferably, the number of C—H and C—C bonds in the resulting polymers is also minimised. Therefore, compounds comprising double and/or triple bonds (referred to throughout the specification as “unsaturated monomers”) are also preferred. Suitable monomers for use in preparing the polymers of the present invention therefore include those selected from the group consisting of ethene, acetylene, tetrafluoroethylene, tetrachloroethylene, propene, butadiene, carbondisulfide, cyclopentadiene, cyclopropene, cyclobutene and cyclobutadiene. Without wishing to be bound by theory, the present inventors consider that minimising vibrational freedom improves transparency of the polymers to IR light. In this way, the present inventors have been able to prepare polymers that have the IR transparency required of components used in IR imaging.

As used throughout the specification, the term “elemental sulfur” refers to the compound of formula S₈ that is found under ambient conditions in the form of a yellow crystalline solid. The term “molten elemental sulfur” refers, throughout the specification, to elemental sulfur that has been heated and has transitioned into a yellow liquid. The melting point of elemental sulfur is about 115° C. To achieve the desired reaction between the molten elemental sulfur and the low molecular weight, rigid, organic monomers, the molten elemental sulfur may be heated at a temperature of between about 140° C. and about 185° C. The molten elemental sulfur may be heated at between about 140° C. and about 160° C., between about 140° C. and about 180° C., between about 140° C. and about 175° C., between about 140° C. and about 170° C., between about 140° C. and about 165° C., between about 140° C. and about 160° C., between about 140° C. and about 155° C., or between about 140° C. and about 150° C. The molten elemental sulfur may be heated at a temperature of about 140° C., about 145° C., about 150° C., about 155° C., about 160° C., about 165° C., about 170° C., about 175° C., about 180° C., or about 185° C.

The weight ratio of the monomers to the elemental sulfur used in the reaction may be from about 1:1 to about 1:10. The weight ratio of the monomers to the elemental sulfur used in the reaction may be about 1:1, about 1:2, about 1:3, about 1:4, about 1:5, about 1:6, about 1:7, about 1:8, about 1:9, or about 1:10. When the weight ratio of the monomers to the elemental sulfur used in the reaction is about 1:1, the resulting polymer may be said to have a sulfur content of about 50%. For a polymer formed from a reaction where the weight ratio of the monomers to the elemental sulfur used in the reaction is about 1:2, the resulting polymer is said to have a sulfur content of about 67%. In the case of a polymer formed from a reaction where the weight ratio of the monomers to the elemental sulfur used in the reaction is about 1:3, the resulting polymer is said to have a sulfur content of about 75%. For a polymer formed from a reaction where the weight ratio of the monomers to the elemental sulfur used in the reaction is about 1:4, the resulting polymer is said to have a sulfur content of about 80%. For a polymer formed from a reaction where the weight ratio of the monomers to the elemental sulfur used in the reaction is about 1:5, the resulting polymer is said to have a sulfur content of about 83%. For a polymer formed from a reaction where the weight ratio of the monomers to the elemental sulfur used in the reaction is about 1:6, the resulting polymer is said to have a sulfur content of about 86%. For a polymer formed from a reaction where the weight ratio of the monomers to the elemental sulfur used in the reaction is about 1:7, the resulting polymer is said to have a sulfur content of about 88%. For a polymer formed from a reaction where the weight ratio of the monomers to the elemental sulfur used in the reaction is about 1:8, the resulting polymer is said to have a sulfur content of about 89%. For a polymer formed from a reaction where the weight ratio of the monomers to the elemental sulfur used in the reaction is about 1:9, the resulting polymer is said to have a sulfur content of about 90%. For a polymer formed from a reaction where the weight ratio of the monomers to the elemental sulfur used in the reaction is about 1:10, the resulting polymer is said to have a sulfur content of about 91%. The corresponding monomer content can then be described as about 50% (where the sulfur content is about 50%), about 33% (where the sulfur content is about 67%), about 25% (where the sulfur content is about 75%), about 20% (where the sulfur content is about 80%), about 17% (where the sulfur content is about 83%), about 14% (where the sulfur content is about 86%), about 12% (where the sulfur content is about 88%), about 11% (where the sulfur content is about 89%), about 10% (where the sulfur content is about 90%), or about 9% (where the sulfur content is about 91%).

The polymer may have a sulfur content of between about 40% w/w and about 90% w/w. The sulfur content may be between about 50% w/w and about 80% w/w, between about 60% w/w and about 70% w/w. Preferably, the sulfur content may be between about 50% w/w and about 70% w/w. The sulfur content may be about 40% w/w, about 45% w/w, about 50% w/w, about 55% w/w, about 60% w/w, about 65% w/w, about 70% w/w, about 75% w/w, about 80% w/w, about 85% w/w, or about 90% w/w.

The polymer may have a monomer content of between about 60% w/w and about 10% w/w. The monomer content may be between about 50% w/w and about 20% w/w, between about 40% w/w and about 30% w/w. Preferably, the monomer content may be between about 50% w/w and about 30% w/w. The monomer content may be about 60% w/w, about 55% w/w, about 50% w/w, about 45% w/w, about 40% w/w, about 35% w/w, about 30% w/w, about 25% w/w, about 20% w/w, about 15% w/w, or about 10% w/w.

Accordingly, in another aspect, the present invention relates to a cured polymer having a sulfur content of between about 40% w/w and about 90% w/w, and a monomer content of between about 60% w/w and about 10% w/w, wherein the monomer is a low molecular weight, rigid, organic monomer, and wherein the polymer is transparent to mid-wave infrared (MWIR) light and long-wave infrared (LWIR) light.

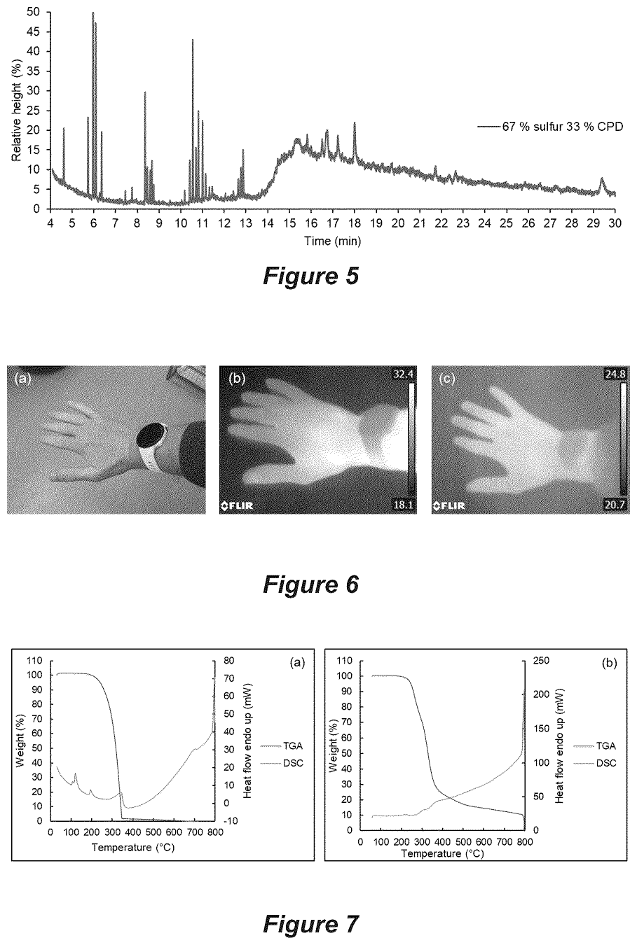

The cured polymer of the present invention may have an IR transmission spectrum comprising the following peaks (cm⁻¹): 3050, 2950, 1700, 1435, 1340-1110, 950, 887, 795, and 676. The polymer of the present invention may have an IR transmission spectrum as shown in FIG. 4(b). The polymer of the present invention may have a gas chromatography-mass spectrometry (GC-MS) spectrum as shown in FIG. 5.

The polymers of the present invention are transparent to MWIR light and LWIR light. For thermal imaging applications, materials should be transparent to MWIR light and LWIR light. As used throughout the specification, the terms “mid-wave infrared light”, “MWIR light”, “MWIR radiation”, and the like are intended to refer to light in the mid-wavelength IR region having a wavelength of from 3 to 5 micrometres (μm). The terms “long-wave infrared light”, “LWIR light”, LWIR radiation, and the like are intended to refer to light in the long-wavelength IR region having a wavelength of from 7 μm to 14 μm. In addition, these wavelengths are outside the absorptions of atmospheric water and carbon dioxide.

The terms “transparent to IR light”, “IR transparency”, and the like are intended to refer to polymers (as well as components comprising, or composed of, the polymers) that allow IR light to pass through them such that the objects emitting the IR light can be detected and/or observed through the polymers and the corresponding components. Transmission is a measure of throughput and is usually given as a percentage of the incident light. For example, the polymer may have a % transmittance of MWIR light of greater than or equal to 50% at a thickness of about 1 mm. The % transmittance of MWIR light was calculated by integrating a % transmittance plot between the range of 3 μm and 5 μm, and then dividing by the range (2 μm). The polymer may have a % transmittance of LWIR light of greater than or equal to 8% at a thickness of about 1 mm. The % transmittance of LWIR light was calculated by integrating a % transmittance plot between the range of 7 μm and 14 μm, and then dividing by the range (7 μm).

A person skilled in the art will be aware of techniques and equipment that can be used to measure the % transmittance of IR light by a substance. For example, the polymer of the present invention may be applied to a KBr disc neat, as a solution (from which the solvent evaporates), or as a suspension (using, for example Nujol mull), followed by inserting the loaded KBr disc into an IR spectrophotometer and measuring the IR spectrum using the spectrophotometer. Alternatively, the polymer can be formed into a sheet and cured, and inserted directly into an IR spectrophotometer, followed my measuring the IR spectrum using the spectrophotometer. An example of a suitable IR spectrophotometer is the Perkin Elmer Frontier FTIR.

The present inventors have also surprisingly found that, by including an additional co-monomer in the polymer, the glass transition temperature (T_{g}) of the polymer can be tuned. In this way, the characteristics of the polymer can be tailored to the requirements of the equipment in which components comprising, or composed of, the polymer will be used. Therefore, an additional co-monomer may also be used in the reacting step. The additional co-monomer, like the organic monomers discussed above, may also be a low molecular weight, rigid, organic compound. The additional co-monomer may be selected from the group consisting of ethene, acetylene, tetrafluoroethylene, tetrachloroethylene, propene, butadiene, carbondisulfide, cyclopentadiene, dicyclopentadiene, norbornene, norbornadiene, cyclopropene, cyclobutene, cyclobutadiene, and episulfide. The additional co-monomer may be unsaturated, and may be selected from the group consisting of ethene, acetylene, tetrafluoroethylene, tetrachloroethylene, propene, butadiene, carbondisulfide, cyclopentadiene, dicyclopentadiene, norbornene, norbornadiene, cyclopropene, cyclobutene and cyclobutadiene.

The additional co-monomer may be used in the reacting step in a weight ratio of from about 1:10 to about 1:1 sulfur to additional co-monomer. The weight ratio of sulfur to additional co-monomer used in the reacting step may be about 1:10, about 1:9, about 1:8, about 1:7, about 1:6, about 1:5, about 1:4, about 1:3, about 1:2 or about 1:1. The weight ratio of sulfur to additional co-monomer used in the reacting step may be about 1:10, about 1:9, about 1:8, about 1:7, about 1:6, about 1:5, about 1:4, about 1:3, about 1:2 or about 1:1. In other words, the additional co-monomer may be used in the reacting step in an amount of between about 1% w/w and 50% w/w of the total mass of sulfur, monomer and co-monomer used in the reacting step. For example, the additional co-monomer may be used in an amount of about 5% w/w, about 10% w/w, about 15% w/w, about 20% w/w, about 25% w/w, about 30% w/w, about 35% w/w, about 40% w/w, about 45% w/w or about 50% w/w of the total mass of sulfur, monomer and additional co-monomer used in the reacting step. In the case where the additional co-monomer is used in an amount of 50% w/w, it will be understood by a person skilled in the art that the remaining 50% w/w is composed of elemental sulfur, and therefore no monomer has been used. The additional co-monomer may be used in an amount of less than about 10% w/w, or even in an amount of less than about 5% w/w of the total mass of sulfur, monomer and additional co-monomer used in the reacting step.

Where an additional co-monomer is used, the molten elemental sulfur may be heated at a temperature of between about 160° C. and about 185° C. The molten elemental sulfur may be heated at a temperature of between about 165° C. and about 185° C., between about 165° C. and about 175° C., or between about 165° C. and about 170° C. The molten elemental sulfur may be heated at a temperature of about 160° C., about 165° C., about 170° C., about 175° C., about 180° C., or about 185° C. The present inventors have surprisingly found that, at a higher temperature, there is a different rate of reaction for certain additional co-monomers compared with monomers. For example, in the case of dicyclopentadiene (the additional co-monomer) and cyclopentadiene (the monomer), at 140° C. a block polymer forms with a section that is mostly cyclopentadiene and another with mostly dicyclopentadiene. However, at 165° C., this does not occur, and instead a co-polymer having both cyclopentadiene and dicyclopentadiene is formed.

The T_{g} of the polymer of the present invention may range from about −15° C. to about 150° C. The T_{g} of the polymer of the present invention may range from about −10° C. to about 140° C. The T_{g} of the polymer may be from about −5° C. to about 140° C. The T_{g} of the polymer may be from about 0° C. to about 140° C. The T_{g} of the polymer may be from about 5° C. to about 140° C. The T_{g} of the polymer may be from about 10° C. to about 140° C. The T_{g} of the polymer may be from about 15° C. to about 140° C. The T_{g} of the polymer may be from about 20° C. to about 140° C. The T_{g} of the polymer may be from about 25° C. to about 140° C. The T_{g} of the polymer may be from about 30° C. to about 140° C. The T_{g} of the polymer may be from about 35° C. to about 140° C. The T_{g} of the polymer may be from about 40° C. to about 140° C. The T_{g} of the polymer may be from about 45 to about 140° C. The T_{g} of the polymer may be from about 50° C. to about 140° C. The T_{g} of the polymer may be from about 55° C. to about 140° C. The T_{g} of the polymer may be from about 60° C. to about 140° C. The T_{g} of the polymer may be from about 65° C. to about 140° C. The T_{g} of the polymer may be from about 70° C. to about 140° C. The T_{g} of the polymer may be from about 75° C. to about 140° C. The T_{g} of the polymer may be from about 80° C. to about 140° C. The T_{g} of the polymer may be from about 85° C. to about 140° C. The T_{g} of the polymer may be from about 90° C. to about 140° C. The T_{g} of the polymer may be from about 95° C. to about 140° C. The T_{g} of the polymer may be from about 100° C. to about 140° C. The T_{g} of the polymer may be from about 105° C. to about 140° C. The T_{g} of the polymer may be from about 110° C. to about 140° C. The T_{g} of the polymer may be from about 115° C. to about 140° C. The T_{g} of the polymer may be from about 120° C. to about 140° C. The T_{g} of the polymer may be about −15° C. to about −5° C., about −5° C. to about 5° C., about 5° C. to about 15° C., about 15° C. to about 25° C., about 25° C. to about 35° C., 35° C. to about 45° C., about 45° C. to about 55° C., about 55° C. to about 65° C., about 65° C. to about 75° C., about 75° C. to about 85° C., about 85° C. to about 95° C., about 95° C. to about 105° C., about 105° C. to about 115° C., about 115° C. to about 125° C., about 125° C. to about 135° C., or about 135° C. to about 145° C.

A person skilled in the art will be aware of techniques and equipment that can be used to measure the T_{g} of a material. The glass-liquid transition, or glass transition, is the gradual and reversible transition in amorphous materials (or in amorphous regions within semicrystalline materials) from a hard state into a viscous or rubbery state as the temperature is increased. The T_{g} of a material characterizes the range of temperatures over which this glass transition occurs.

Typically, a Differential Scanning Calorimeter (DSC, such as the DSC 8000 from Perkin Elmer) can be used to measure the T_{g} of a material. In the case of a power-differential DSC, the sample and reference crucible are placed in separate thermally-insulated furnaces, with the temperature of both chambers controlled so that the same temperature is always present in both furnaces. Generally, the temperature program for a DSC analysis is designed such that the sample holder temperature increases linearly as a function of time. The amount of power required to maintain system equilibrium is directly proportional to the energy changes occurring in the sample, and, by recording the change in the amount of power required as the temperature increases, the range of temperatures over which the glass transition occurs can be determined. For example, a sample of a film composed of the polymer of the present invention and a reference crucible (e.g. aluminium oxide) can be cooled to very low temperatures in the DSC (e.g. −50° C.), and then the temperature can be increased incrementally to a high temperature (e.g. 130° C.). The temperature can be cycled through from low to high more than once, and, by observing the change in power over these cycles, the T_{g} of the polymer can be determined.

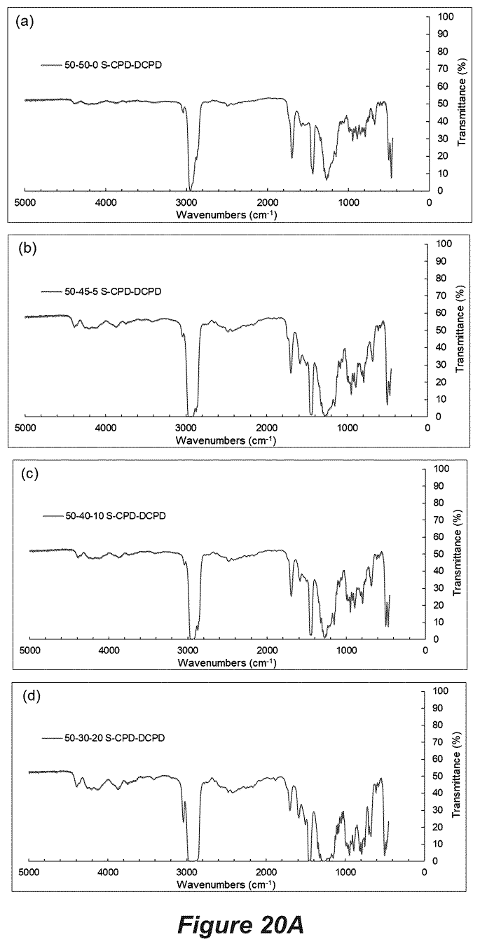

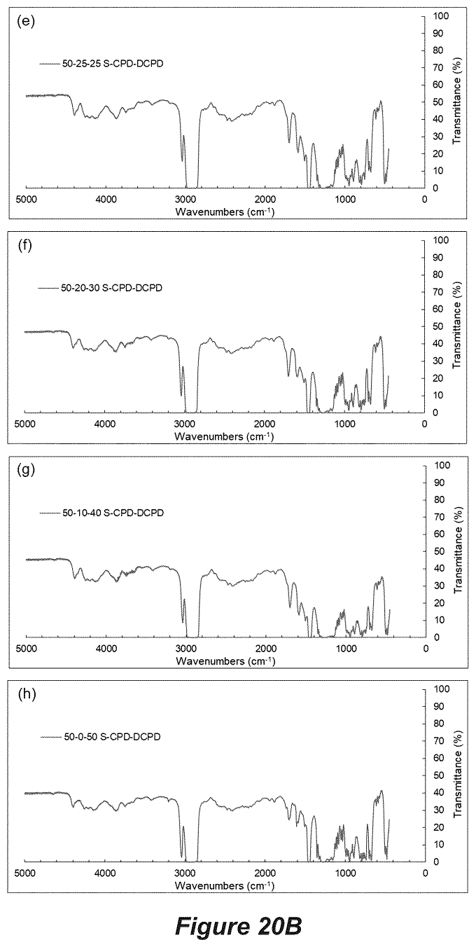

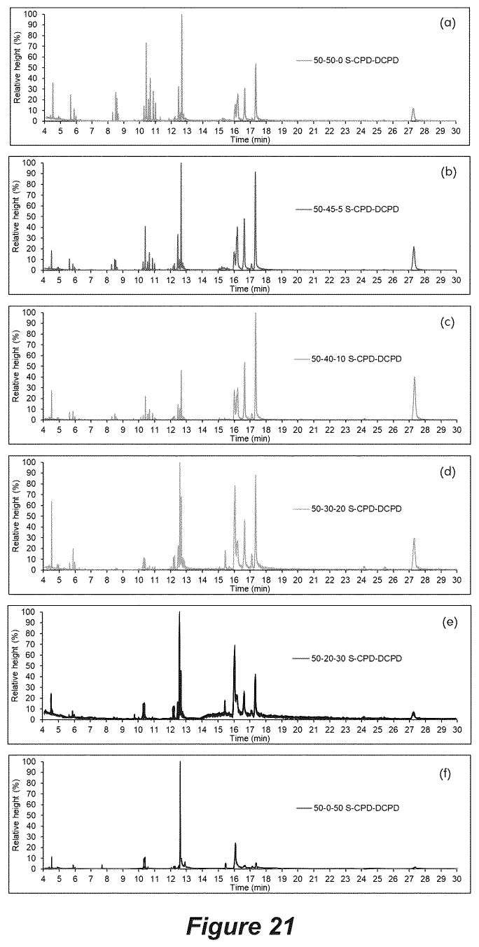

The polymer of the present invention, when comprising an additional co-monomer, may have an IR transmission spectrum as shown in FIG. 20A(a), FIG. 20A(b), FIG. 20A(c), FIG. 20A(d), FIG. 20B(e), FIG. 20B(f), FIG. 20B(g), or FIG. 20B(h). The polymer of the present invention, when comprising an additional co-monomer, may have a GC-MS spectrum (following reduction) as shown in FIG. 21(a), FIG. 21(b), FIG. 21(c), FIG. 21(d), FIG. 21(e), or FIG. 21(f).

A further compound (referred to herein as an “additive”) may also be added to the polymer. This may be useful if, for example, the transmittance or refractive properties are sought to be altered. Therefore, an additive may also be used in the reacting step. The additive may be selected from selenium, tetravinyltin, dicyclopentadiene, norbornadiene and norbornene. The additive may be added in a weight ratio of additive to the sulfur of from about 1:10 to about 1:1. The additive may be added as a mixture with the monomer and/or additional co-monomer.

A high refractive index (e.g. n=2 or higher) is important for materials used in IR imaging applications. The refractive index of a lens material is directly related to its focussing power. A high refractive index is desirable to limit the amount and size of a lens, which in turn saves space in an imaging system and decreases the contribution that the lens makes to the overall weight of an imaging system.

In some embodiments, the polymers have the added advantage of being black in colour, thereby allowing the polymer to be used in applications where it is desirable to conceal IR imaging equipment, such as in defence. Accordingly, the polymer may have a % transmittance of visible light of about 0% at a thickness of about 1 mm. The polymer may have a % transmittance of visible light of less than about 5%, less than about 4%, less than about 3%, less than about 2%, or less than about 1%, at a thickness of about 1 mm. Essentially, the polymers of the present invention are not transparent to visible light. That is, they are opaque. The term “visible light” as used herein has the usual meaning as understood by a person skilled in the art, and thus refers to the portion of the electromagnetic spectrum that is visible to the human eye. A typical human eye will respond to light wavelengths from about 380 to about 750 nanometres (nm). In fact, the polymers of the present invention have no transmission from 250 nm to 950 nm at a thickness of 1 mm. The % transmittance of visible light was calculated by integrating a % transmittance plot between the range of 380 nm and 700 nm, and then dividing by the range (320 nm).

A person skilled in the art will be aware of techniques and equipment that can be used to measure the % transmittance of visible light by a substance. For example, the polymer can be formed into a sheet and cured, and inserted directly into a UV-vis spectrometer, followed my measuring the spectrum using the spectrometer. An example of a suitable spectrometer is the Perkin Elmer Lambda 950 UV-Vis-NIR spectrometer.

In order to prepare a component for use in IR imaging applications, which component comprises, or is composed of, the polymer of the present invention, it is important to cure the prepared polymer. The polymer may be cured by heating. The polymer may be placed or poured into, and then cured in, a mould (such as a heat-resistant silicone resin), so as to give a component of a particular shape and size. The polymer may be cured at a temperature of about 100° C. to about 160° C. The polymer may be cured at a temperature of about 110° C. to about 150° C., or about 120° C. to about 140° C. The polymer may be cured at a temperature of about 100° C., about 110° C., about 120° C., about 130° C., about 140° C., about 150° C., or about 160° C. The polymer may be subjected to hot pressing. Prior to hot pressing, the polymer may be cured and ground into a powder. The hot pressing may be done at a temperature of from about 100° C. to about 180° C. The hot pressing may be done at a temperature of about 105° C., about 110° C., about 115° C., about 120° C., about 125° C., about 130° C., about 135° C., about 140° C., about 145° C., about 150° C., about 155° C., about 160° C., about 165° C., about 170° C., about 175° C., or about 180° C. The component may be any shape and size that is suitable for the particular application and equipment, and examples include a sheet, window, sample cell, waveguide or filter. The component may have a thickness equal to, or less than, about 2 mm. The component may have a thickness equal to, or less than, about 1.5 mm. The component may have a thickness equal to, or less than, about 1.4 mm. The component may have a thickness equal to, or less than, about 1.3 mm. The component may have a thickness equal to, or less than, about 1.2 mm. The component may have a thickness equal to, or less than, about 1.1 mm. The component may have a thickness equal to, or less than, about 1 mm. The component may have a thickness equal to, or less than, about 0.9 mm. The component may have a thickness equal to, or less than, about 0.8 mm. The component may have a thickness equal to, or less than, about 0.7 mm. The component may have a thickness equal to, or less than, about 0.6 mm. The component may have a thickness equal to, or less than, about 0.5 mm. The component may be a lens. The lens may be a positive (converging) or negative (diverging) lens. The lens may be a plano convex, plano concave, bi-convex, bi-concave, Fresnel, positive meniscus or negative meniscus lens.

The cured polymer may be coated to reduce reflection in the component in which the polymer is used. Suitable substances that may be used as a coating for this purpose include silica nanoparticles, MgF₂, and various fluoropolymers.

The present invention also relates to a method of producing a cured polymer that is transparent to mid-wave infrared (MWIR) light and long-wave infrared (LWIR) light, the method comprising:
a) providing molten elemental sulfur;
b) adding, to the molten elemental sulfur, low molecular weight, rigid, organic monomers, in aliquots, to produce a mixture, wherein the aliquots are added such that the sulfur does not crystallise;
c) optionally further heating the mixture;
thereby preparing a polymer, and
d) curing the prepared polymer.

The present inventors have found, for the first time, that monomers in a gaseous state can be successfully reacted with molten elemental sulfur to produce polymers. Before the present invention, it was widely accepted that molten elemental sulfur cannot be reacted successfully with monomers that are not in a liquid or solid state. Contrary to this teaching, in the method of producing polymers according to the present invention, the monomers may be in a gaseous state. An additional co-monomer may also be added to the molten elemental sulfur. The additional co-monomer may be added as a mixture with the monomers. The additional co-monomer may be in a gaseous state. The monomers in a gaseous state may be introduced directly into the molten elemental sulfur by, for example, bubbling the monomers through the molten elemental sulfur. In one form, the monomers have a boiling point that is above room temperature and below the melting point of molten sulfur. The monomers are preferably low molecular weight, rigid, organic monomers. The monomers may be selected from norbornadiene, norbornene, carbondisulfide, butadiene, episulfide, cyclopropene, and cyclobutene.

As discussed above, to achieve the desired reaction between the molten elemental sulfur and the low molecular weight, rigid, organic monomers, the molten elemental sulfur may be heated at a temperature of between about 140° C. and about 185° C. The molten elemental sulfur may be heated at between about 140° C. and about 160° C., between about 145° C. and about 180° C., between about 145° C. and about 175° C., between about 145° C. and about 170° C., between about 145° C. and about 165° C., between about 150° C. and about 160° C., or between about 150° C. and about 155° C. The molten elemental sulfur may be heated at a temperature of about 145° C., about 150° C., about 155° C., about 160° C., about 165° C., about 170° C., about 175° C., about 180° C., or about 185° C.

The present inventors have also found that some monomers, if added too quickly to the molten elemental sulfur, caused the sulfur to cool rapidly, resulting in some of the sulfur crystallising. This issue was avoided by adding the monomers in smaller aliquots.

The monomers may be added to the elemental sulfur in a total amount of from about 1:1 to about 1:10 (weight ratio) of monomers to elemental sulfur. The weight ratio of the monomers to the elemental sulfur may be about 1:1, about 1:2, about 1:3, about 1:4, about 1:5, about 1:6, about 1:7, about 1:8, about 1:9, or about 1:10.

The optional further heating step may be useful where the reaction is not complete by the time the total amount of the monomers has been added. The present inventors have found that a change in colour of the mixture to black and an increase in the viscosity of the mixture usually serve as useful indicators of the completion of the reaction.

The present invention also relates to a method of producing a component for use in infrared (IR) imaging applications, the component composed of, or comprising, a cured polymer that is transparent to mid-wave infrared (MWIR) light and long-wave infrared (LWIR) light, the method comprising:
a) providing molten elemental sulfur;
b) adding, to the molten elemental sulfur, low molecular weight, rigid, organic monomers in aliquots to produce a mixture, wherein the aliquots are added such that the sulfur does not crystallise;
c) optionally further heating the mixture;
thereby preparing a polymer, and
d) curing the prepared polymer.

The polymer may be cured by heating, and may be cured in a mould, as mentioned above. The cured polymer may be subjected to hot pressing, as discussed above.

The component may have a % transmittance of MWIR light of greater than or equal to 50% at a thickness of about 1 mm. Alternatively, or in addition, the component has a % transmittance of LWIR light of greater than or equal to 8% at a thickness of about 1 mm. The component may have a % transmittance of visible light of about 0% at a thickness of about 1 mm.

The present invention also relates to an apparatus for polymerising molten elemental sulfur with monomers in a gaseous state, the apparatus comprising a first sealed vessel, the first sealed vessel comprising:
molten elemental sulfur;
a port through which monomers in a gaseous state are introduced into the first sealed vessel, such that the monomers reside in the headspace above the molten elemental sulfur;
an outlet through which the monomers are introduced directly into the molten elemental sulfur; and
an inlet in fluid communication with both the outlet and with the headspace above the molten elemental sulfur,
wherein the monomers are continuously circulated from the headspace through the inlet and out of the outlet into the molten elemental sulfur such that the monomers undergo a polymerisation reaction with the molten elemental sulfur.

As used herein, a “vessel” may be any container that can be sealed such that the monomers in the gaseous state are retained in the apparatus. For example, the vessel may be a round-bottom flask which is sealable by means of one or more stoppers and/or septums (e.g. rubber septums). The vessel will comprise one or more ports, which may be used as a means for, for example, connecting to other equipment (e.g. one or more additional vessels, condensers, and the like) that forms part of the apparatus. The ports will provide, for example, through the presence of adapters or septa, or direct fusing to a connector, a means for achieving a connection that is gas tight. In this way, any connection to another piece of equipment via the port will not result in the loss of a gaseous substance (e.g. monomers in the gas phase) passing through the port.

The apparatus may further comprise a second sealed vessel, wherein the second sealed vessel is used to generate the monomers in a gaseous state. The gaseous monomers may be generated by, for example, heating a solution comprising the monomers to the boiling point of the monomers, such that the monomers transition from the liquid phase to the gas phase. The second sealed vessel may comprise a first port by means of which the second sealed vessel is connected to the port of the first vessel such that the monomers in the gas phase generated in the second vessel pass into the first vessel. The second vessel may be connected to the first vessel by any suitable means that allow the monomers in the gas phase to pass from the second vessel into the first vessel without loss of the gaseous monomers to the external environment. This may be a tube or a pipe, or the like. A glass tube may be used. Once in the first vessel, the gaseous monomers will occupy the headspace above the molten elemental sulfur.

The second vessel may comprise a second port by means of which the second sealed vessel is connected to a condenser, such as a water-cooled reflux condenser. The presence of a condenser may be useful where, for example, the solution comprising the monomers is a mixture, or turns into a mixture over time, and the other component(s) of the mixture have a higher boiling point than the monomers that are desired to be reacted with the sulfur. Any other oligomers that are formed in the reflux of the monomers thus remain in the vessel with the attached condenser and do not participate in the reaction with the molten sulfur. Due to the lower boiling point of the monomers, once in the gaseous state they are able to pass from the vessel in which they have been generated into the vessel containing the molten sulfur.

The apparatus also comprises an outlet through which the gaseous monomers are introduced directly into the molten elemental sulfur. The outlet will typically comprise an aperture, and may be, for example, a hollow needle or other similar device that allows the gaseous monomers to come into contact with the molten sulfur so as to facilitate the reaction between the molten sulfur and monomers in the gaseous state. In this way, the gaseous monomers may bubble through the molten sulfur, thereby increasing the likelihood of a successful reaction between the molten sulfur and the gaseous monomers. The outlet is in fluid communication with an inlet—this arrangement allows the gaseous monomers from the headspace to be taken up by the inlet and passed out through the outlet directly into the molten elemental sulfur. The outlet may be connected to the inlet by means of a pump. The inlet may be any suitable means for taking the gaseous monomer from the headspace, and will typically comprise an aperture. The inlet may be of the same type as the outlet. The inlet may be, for example, a hollow needle or other similar device.

The apparatus may also comprise a means for heating the first sealed vessel to allow the molten elemental sulfur to be prepared and heated to the temperature at which the reaction between the molten sulfur and the gaseous monomers can occur. The apparatus may also comprise a means for heating the second sealed vessel to facilitate the generation of the gaseous monomers. For these purposes, any suitable heating means (such as oil baths or jacket heaters) may be used.

The first sealed vessel may also comprise a stirrer (such as a stirring bar or rod), to facilitate the mixing of the molten elemental sulfur with the gaseous monomers.

In one form, the monomers have a boiling point that is above room temperature and below the melting point of molten sulfur. The monomers are preferably low molecular weight, rigid, organic monomers. The monomers may be selected from norbornadiene, norbornene, carbondisulfide, butadiene, episulfide, cyclopropene, and cyclobutene.

### EXAMPLES

### Example 1—Mould Design for Polymer Windows

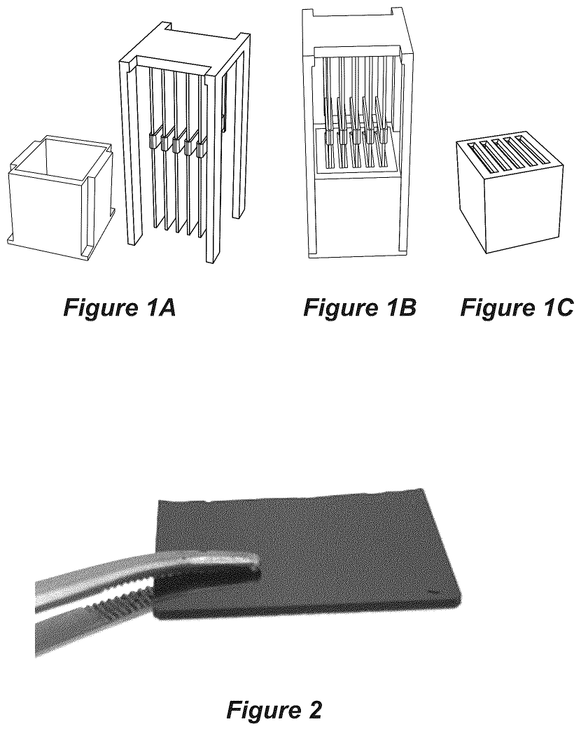

A mould was designed so polymers can be cured to give a width of 1 mm and have the appropriate size and shape for infrared transmission testing. To produce this mould, 1 mm thick glass slides were used as a negative. A 3D printed part was designed to hold up to five glass slides. These glass slides were positioned in another 3D printed part so that they were 5 mm from the bottom of a 35 mm wide, 40 mm long and 33 mm deep opening. Optionally, small 3D printed parts can be added to each glass slide to make it easier to pour pre-polymer into the mould. A heat resistant, fast-set silicone resin (Pinkysil) composed of polydimethylsiloxane (PDMS) was prepared according to the manufacturer's instructions and then poured around the glass slides to prepare a mould, and left to cure for two hours. This mould produced polymer windows with dimensions of 25 mm×25.4 mm×1 mm. See FIG. 1 for images depicting various stages of the mould's synthesis. To remove the polymer film from the mould, the silicone was cut with a scalpel.

### Example 2—Polymer Prepared from Sulfur and Cyclopentadiene, and Preparation of a Polymer Window

Cyclopentadiene can be produced from dicyclopentadiene in a retro-Diels Alder reaction. To initiate this reaction, the dicyclopentadiene must be heated to above 150° C. where the retro Diels Alder reaction becomes favoured to produce cyclopentadiene. The cyclopentadiene can then be separated by distillation due to its much lower boiling point. In one experiment to produce cyclopentadiene, 20 g of dicyclopentadiene was weighed and added to a 100 mL round-bottom flask with a magnetic stirrer. The round-bottom flask was added to a standard distillation setup with a water-cooled condenser, and slowly heated to 180° C. Another 100 mL round-bottom flask was used as an outlet to collect the cyclopentadiene. The outlet round-bottom flask was cooled with an ice bath to reduce the rate of the Diels Alder conversion back to dicyclopentadiene. The cyclopentadiene was used immediately after distillation to reduce the chance that dicyclopentadiene is reformed. ¹H NMR was used to confirm the purity of the cyclopentadiene after distillation. The cyclopentadiene was kept in the freezer and checked by ¹H NMR to determine if any dicyclopentadiene that had reformed. If it was found that the proportion of dicyclopentadiene was above 2%, the cyclopentadiene was distilled again at 70° C. to separate it from dicyclopentadiene.

The polymer samples were prepared through an inverse vulcanization reaction between sulfur and cyclopentadiene. Sulfur (3 g) was added to a 21 mL scintillation vial with a magnetic stirrer. A threaded adapter was used to attach this vial to a water-cooled condenser. An oil bath was preheated to 165° C. and an oven was preheated to 140° C. The sulfur was lowered into the oil bath and heated for 3 minutes to initiate ring opening polymerisation and melt it to form a yellow liquid. After 3 minutes, 1.5 g cyclopentadiene was added with a volumetric pipette down the reflux condenser. The cyclopentadiene should be added slowly or the sulfur may crystallise due to rapid cooling—it was found that the cyclopentadiene can be added in 300 μL additions every 3 minutes. For the composition of 3 g sulfur and 1.5 g cyclopentadiene (67% sulfur, 33% cyclopentadiene, w/w), the reaction would take a total time of 40 minutes from when the sulfur is first added. Over this time, the sample would slowly darken and increase in viscosity. The sample was then added to a silicon mould (as prepared in Example 1) and cured in an oven at 140° C. for 24 hours. After curing, the polymer was left at room temperature to cool before being removed from the silicon mould.

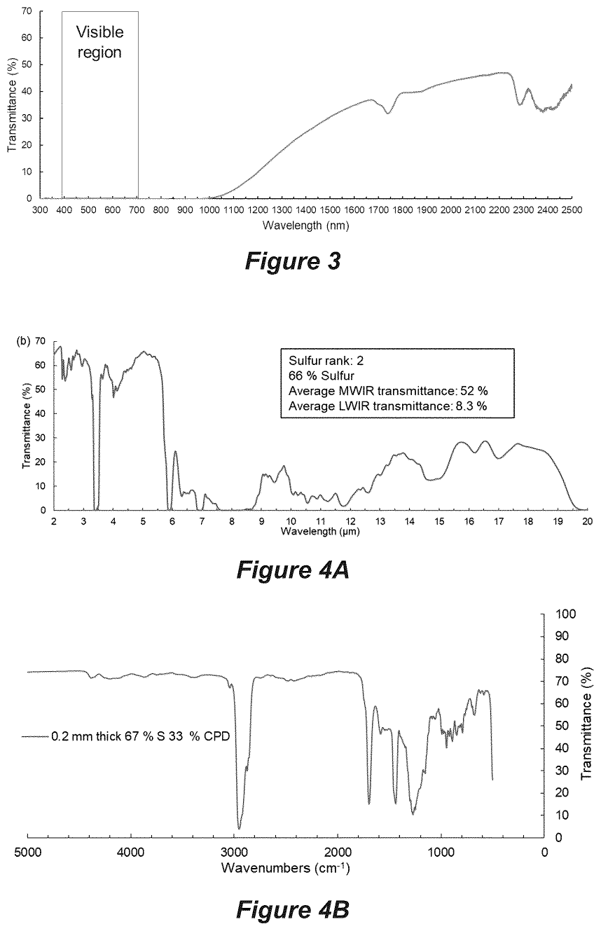

The polymer window was black (see FIG. 2) and not transparent to visible light. As shown in FIG. 3 (tested on a Perkin Elmer Lambda 950 UV-Vis-NIR spectrometer), near-zero transmittance in the visible region is consistent with the opaque, black colour, and increased transmission was observed from 1000 cm⁻¹. The refractive index varied from n=1.9 to 2.1 over IR wavelengths of 500 to 8000 cm⁻¹. FIG. 4(a) shows an IR spectrum of the polymer film—the key regions of transparency are observable at wavelengths of 3 μm to 5 μm and 9 μm to 12 μm. A thermal image of a human hand was also obtained through the polymer film as shown in FIG. 6, which demonstrates that the polymer film is transparent to IR light at wavelengths used for thermal imaging.

The polymer window was also analysed with a Perkin Elmer STA8000 Simultaneous Thermal Analyser to assess its thermal stability. It was heated from 60° C. to 800° C. at a temperature ramp rate of 20° C./minute under a flow of nitrogen. The results are shown in FIG. 7. At 800° C., the gas was switched to air for 10 minutes to burn off any remaining polymer. The DSC trace shows no sulfur melting peaks between 100° C. and 200° C. for this polymer when cured, indicating that the sulfur is stabilised within the polymer when cured. The Thermogravimetric Analysis (TGA) trace shows two large mass losses, the first at around 215° C. and the second at 300° C. These mass losses correspond to 27% and 46% of the mass of the sample respectively. A further 11% is lost between 370° C. and 510° C. and 6% is lost between 510° C. and 800° C. 10% of the polymer does not break down at 800° C. under nitrogen and is only burnt off after oxygen is added to the DSC atmosphere. This is very different to sulfur, which loses almost all of its mass by 350° C.

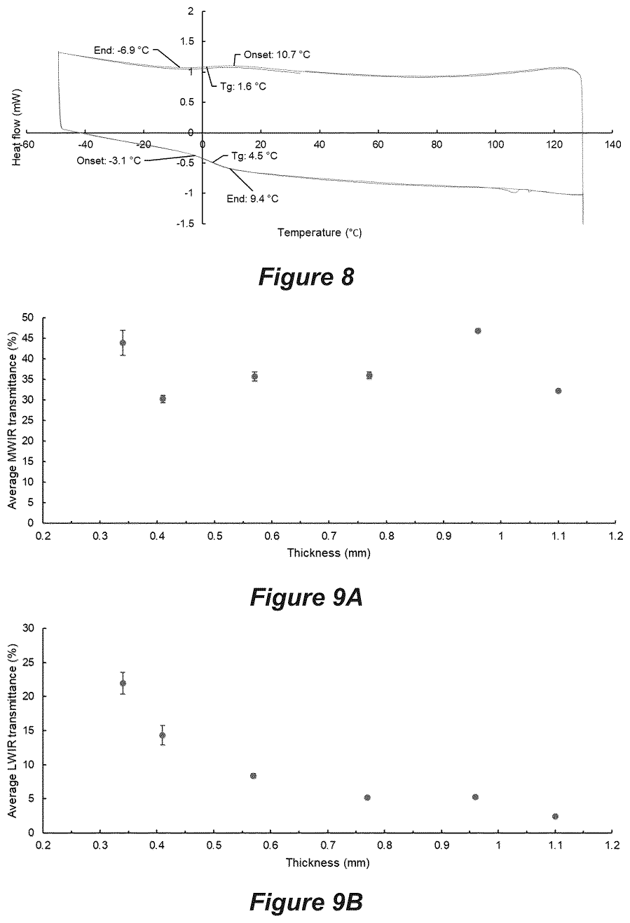

The polymer window was also analysed by DSC to determine its T_{g}. Using a Perkin Elmer DSC 8000 and starting from 30° C., the polymer was cooled to −50° C. at 5° C./minute under nitrogen. The temperature was then cycled from −50° C. to 130° C. twice to find the T_{g}. The polymer showed a T_{g} of approximately 3° C., making it flexible at room temperature (see FIG. 8).

The polymer was also produced in a range of thicknesses from 0.34 mm to 1.1 mm by producing a mould using glass microscope cover slips as a negative, as described above. The polymer samples were tested using a Perkin Elmer Frontier FTIR spectrometer. The average transmission between 3 μm and 5 μm was assigned as the MWIR region. The average transmission between 7 μm and 14 μm was assigned as the LWIR region. As can be seen from FIG. 9, the average MWIR transmission remains consistent over the range of thicknesses tested. This indicates that absorbance by the polymer is likely not responsible for most of the losses in transmission in this region, with reflection from the polymer surface being the most likely dominant cause for the losses in transmission. However, in the LWIR region, the average transmission decreases as thickness increases, which seems to indicate that, in this region, absorbance by the polymer is likely a significant factor.

### Example 3—Preparation of a Polymer Sheet for Concealment and Protection

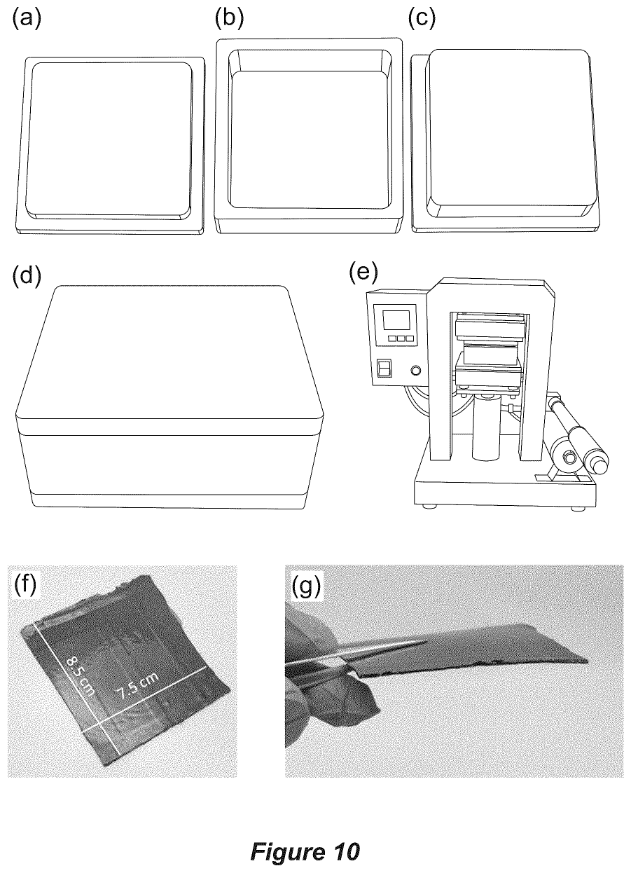

Three batches of the sulfur-cyclopentadiene polymer were prepared using the method described in Example 2. After curing, the polymer from all three batches was ground into a powder and added to an aluminium hot press. Baking paper was used to ensure the polymer could be removed from the aluminium press afterwards. The press was heated to 140° C. and compressed to 30 Mpa for 10 minutes. After this time, the polymer was allowed to cool and was cut into an 85 mm by 75 mm sheet. The thickness of the sheet was 0.83 mm and the final mass was 7 g. Images of the hot press used, and the polymer sheet produced using this method, are given in FIG. 10.

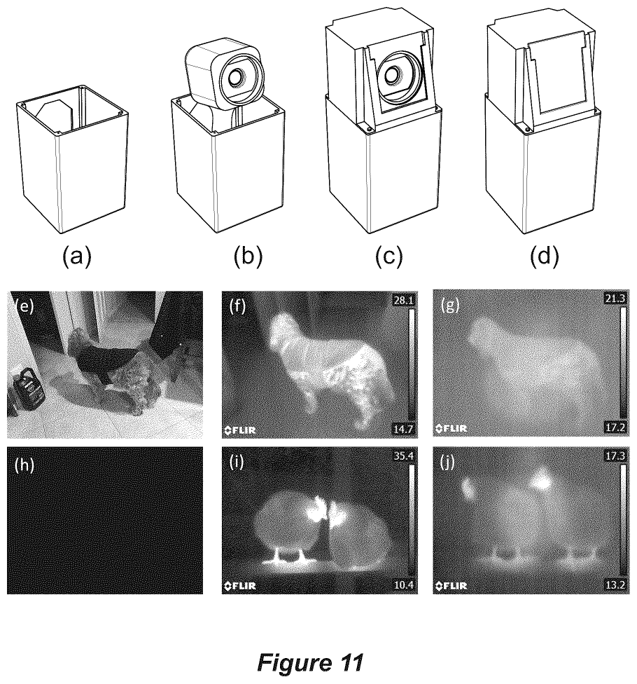

A casing for an IR camera, which could hold the camera and the polymer sheet, was designed and 3D printed. This was used to test the use of this polymer as a barrier to both hide and protect the camera while still allowing IR radiation to pass through, and thus demonstrate the potential application of a polymer sheet in concealment and surveillance. The camera and casing are shown in (a) to (d) of FIG. 11, and the use of the camera is illustrated in (e) and (g) of FIG. 11: (e) optical image of dog; LWIR image with FLIR E6 camera both (f) without polymer, and (g) through the polymer. In (h) to (j) of FIG. 11, the use of LWIR imaging in low-light conditions is demonstrated: the optical image (h) shows nothing in the dark, but the IR image ((i) with no polymer and (j) through the polymer) is unaffected.

### Example 4—Preparation of Polymer Lenses

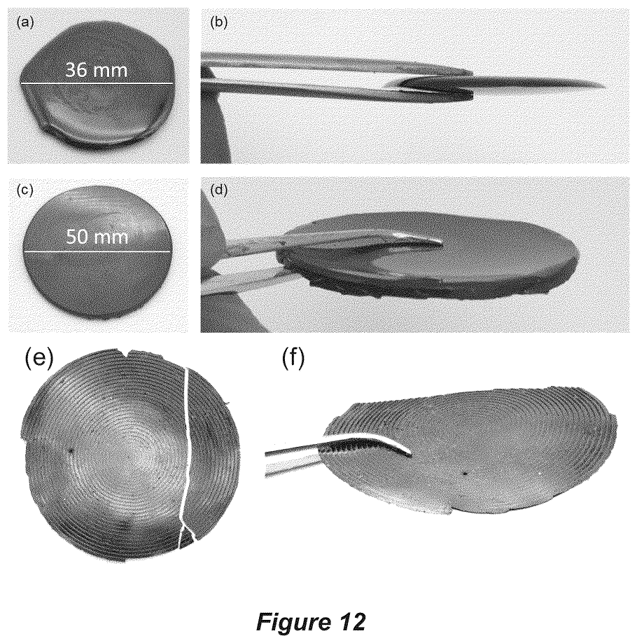

A polymer produced according to Example 2 was used to produce three lenses which can be used to magnify or reduce images. The diverging lens (reducing lens) was a plano concave lens with a diameter of 50 mm, an edge thickness of 4 mm and a centre thickness of 1.5 mm. Two converging lenses (magnifying lenses) were also produced: a Fresnel lens (dimensions of 76.2 mm by 76.2 mm and a thickness of 0.508 mm), and a plano convex lens with a diameter of 36 mm, a centre thickness of 1.8 mm and no edge thickness. A mould of each of the lenses was made using a heat resistant silicone resin using the same method as described in Example 2 for the polymer windows, but the flat face of the moulds was open. Two batches were made of each of the Fresnel and plano convex lenses, and three for the plano concave lens. The polymer was directly poured into the mould and cured in place before the lenses were used. Images of the plano convex ((a) and (b)), plano concave ((c) and (d)), and Fresnel ((e) and (f)) lenses are shown in FIG. 12.

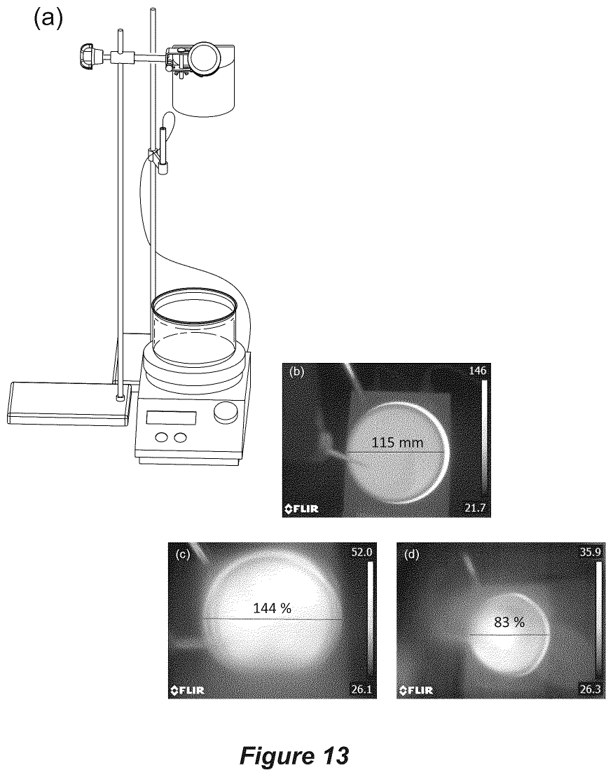

The polymer lenses were tested by holding an FLIR camera 30 cm from an oil bath heated to 100° C. (see FIG. 13(a)). The lenses were then placed in front of the camera. The diameter of the oil bath relative to the image with no lens (i.e. (b)) is shown to demonstrate the magnification (c) or reduction (d) capability of the lenses. As can be seen from (c) and (d) of FIG. 13, the cured polymer is shape persistent and can be used to make functional IR lenses.

### Example 5—IR Transmission Testing of Polymers with Different Sulfur:Cyclopentadiene Ratios

Cured polymer samples were prepared according to the method described in Example 2, using the following monomer:sulfur ratios:
a. 1:1-50% sulfur, sulfur rank 1;
b. 1:2-67% sulfur, sulfur rank 2;
c. 1:3-75% sulfur, sulfur rank 3; and
d. 1:4-80% sulfur, sulfur rank 4.

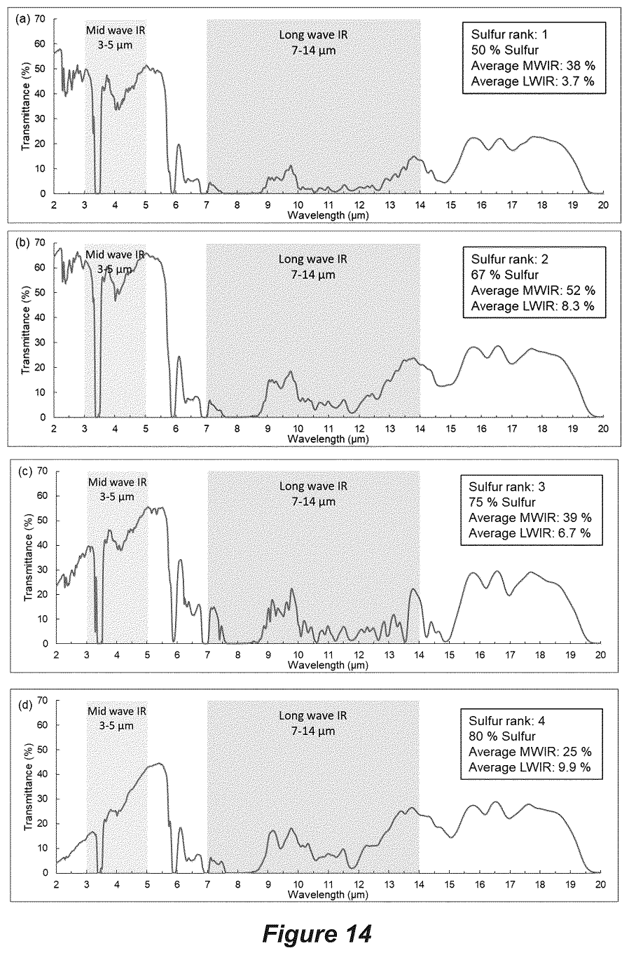

The 1 mm thick polymer samples were tested for IR transmission in the MWIR and LWIR regions using a Perkin Elmer Frontier FTIR. In transmission mode, the polymer samples were tested in the wavelength range of 2 μm to 20 μm over a total of 16 scans. The results are shown in FIG. 14. It was found that cyclopentadiene and sulfur polymers showed excellent transmission in both the MWIR (3 μm to 5 μm) and LWIR (7 μm to 14 μm) regions for polymers of this thickness. The greatest transmission properties came when polymers were prepared with an average sulfur rank of two.

### Example 6—Controlling Glass Transition Temperature (T_{g}) Through the Use of Additional Co-Monomers

Solutions of dicyclopentadiene (DCPD) in cyclopentadiene (CPD) were produced. Each solution had a total mass of 3 g, and the ratio of DCPD to CPD was varied from 0 (100% CPD) to 0.8 (80% DCPD). These solutions were reacted with sulfur using the same method as described in Example 2. 3 g of sulfur was used in each experiment, giving an equal mass of sulfur to monomer/co-monomer in each reaction. In each experiment, the sulfur was heated at 165° C. with stirring (500 rpm) for 3 minutes, and a water-cooled condenser was attached to the flash containing the sulfur. After 3 minutes, 300 μL of the CPD/DCPD solution was added directly to the sulfur with a long needle, so that the solution could be applied directly to sulfur (rather than at the top of the condenser, as per Example 2). This prevented DCPD from getting stuck in the condenser. The CPD/DCPD solution was added at 300 μL every 3 minutes until it had all been added. The samples were removed from the heat when viscosity increased and the magnetic stirrer bar could no longer stir at 500 rpm, which would typically take between 45 and 60 minutes. Polymers with a greater amount of DCPD would take a shorter amount of time to react. A polymer was also produced using 3 g of DCPD and no CPD. For this polymer, the method was modified as DCPD is a solid at room temperature. The 3 g of DCPD was weighed into 0.294 g portions. These portions were added every three mins directly to the sulfur (preheated to 165° C.). Table 1 sets out all of the compositions of polymers that were produced.

TABLE 1
Compositions of polymers produced based
on amount of sulfur, CPD and DCPD used.

| Composition | Sulfur mass (g) | CPD mass (g) | DCPD mass (g) |
|---|---|---|---|
| 50-50-0 | 3 | 3 | 0 |
| 50-45-5 | 3 | 2.7 | 0.3 |
| 50-40-10 | 3 | 2.4 | 0.6 |
| 50-30-20 | 3 | 1.8 | 1.2 |
| 50-25-25 | 3 | 1.5 | 1.5 |
| 50-20-30 | 3 | 1.2 | 1.8 |
| 50-10-40 | 3 | 0.6 | 2.4 |
| 50-0-50 | 3 | 0 | 3 |

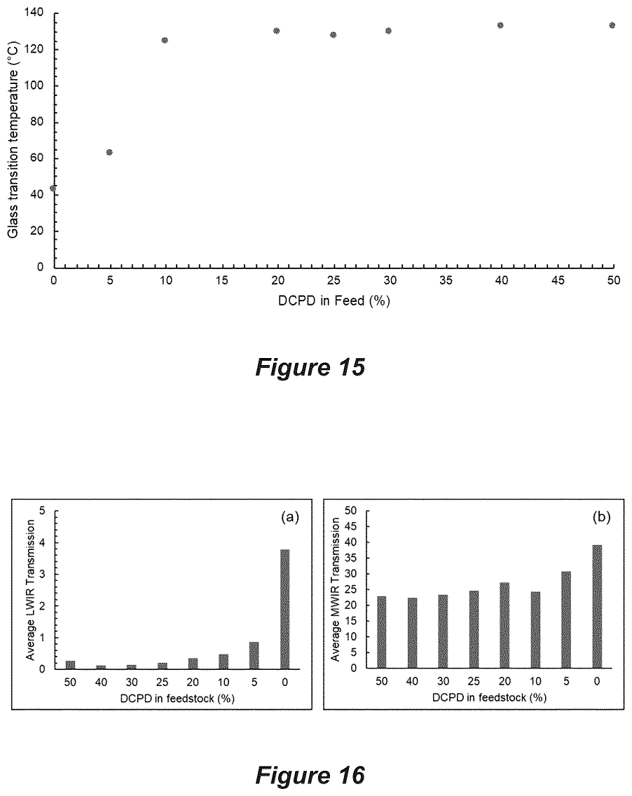

All polymers were analysed by DSC using a Perkin Elmer DSC 8000 to find a glass transition temperature (T_{g}). Starting from 30° C., the polymer samples were cooled to −80° C. at 5° C./minute. The temperature was then cycled from −80° C. to 150° C. twice to find the T_{g}. All samples were analysed under nitrogen. The results are presented in FIG. 15 (T_{g} versus DCPD content). The T_{g} increased as the DCPD content increased. When only CPD was used, the T_{g} was around room temperature but it quickly increased to over 100° C. as DCPD content was increased to 10%. The T_{g} of all other samples did not change much as the DCPD content increased.

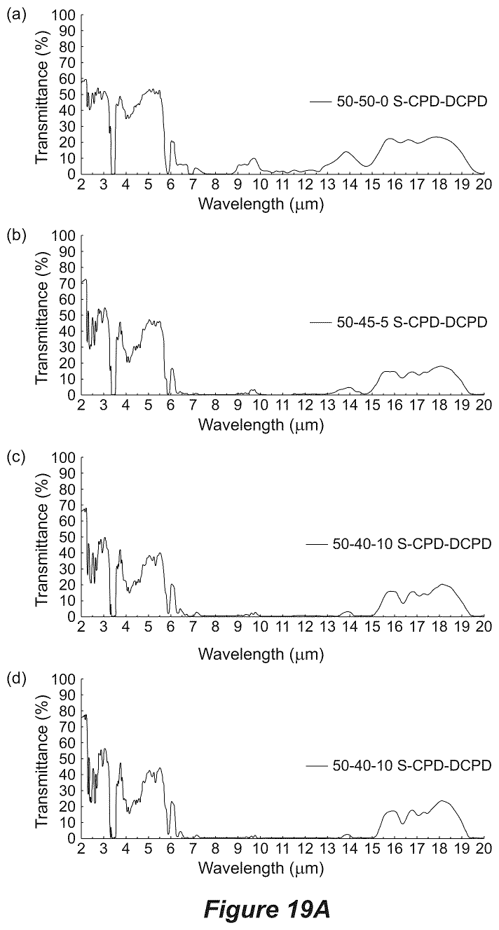

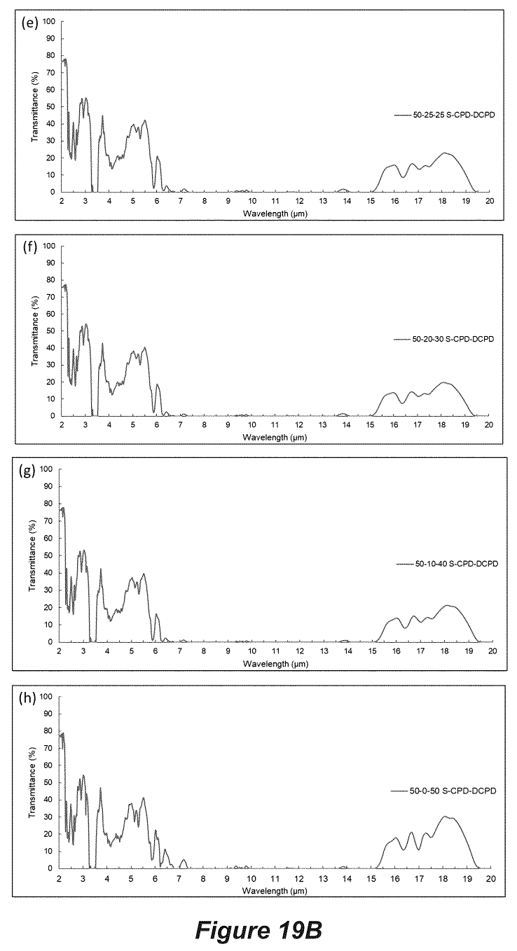

The polymers produced were also cured and made into 1 mm and 0.2 mm thick sheets. The IR transmission spectra for the 1 mm polymer sheets are shown in FIGS. 16, 19A and 19B. As can be seen from these Figures, with regard to MWIR, the presence of DCPD does not compromise IR transparency. Above 5% DCPD the LWIR transparency is slightly reduced. The IR transmission spectra for the sheets of about 0.2 mm thickness are given in FIGS. 20A and 20B.

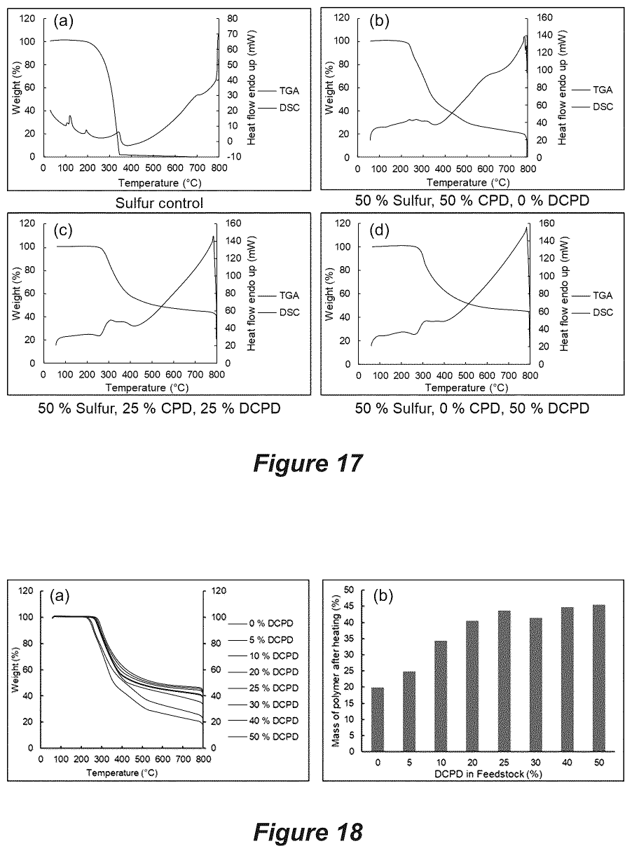

All polymers were analysed with a Perkin Elmer STA 8000 to assess thermal stability. The samples were heated from 60° C. to 800° C. at a temperature ramp rate of 20° C./minute under a flow of nitrogen. At 800° C., the gas was switched to air for 10 minutes to burn off any remaining polymer. As can be seen from FIG. 17, the DSC did not show the characteristic sulfur melting peak at 119° C. for any samples, indicating that there is no unreacted sulfur after curing. The sample with only CPD showed an additional mass loss with an onset of 215° C. This mass loss decreased in the samples with less CPD and was not visible in the sample which only contained DCPD in the feedstock. Furthermore, the final mass of polymer which was not lost under nitrogen was affected by the DCPD ratio in the polymer (see FIG. 18). As more DCPD was added, the final mass increased from 20% to 45%.

All polymers were reduced with sodium borohydride so that the composition of the polymers could be analysed despite its low solubility in most solvents. The sodium borohydride was used to reduce many of the sulfur-sulfur bonds to leave small molecules that could be analysed by Gas Chromatography-Mass Spectrometry (GC-MS). 30 mg of each polymer was ground into a powder and weighed into a flame dried 50 mL 2-necked round-bottom flask. 94 mg of sodium borohydride was weighed into the same round-bottom flask under a stream of nitrogen. The main neck of the round-bottom flask was added to an air condenser with a nitrogen line. The condenser and round-bottom flask were purged with nitrogen for 30 minutes to ensure all oxygen was removed from the reaction atmosphere. After purging, the outlet needle was removed but a constant flow of nitrogen was maintained. 2.5 mL of anhydrous THF was injected into the round bottomed flask and the mixture was stirred at 500 rpm. The round-bottom flask was then added to a 50° C. oil bath. While stirring was maintained, the mixture was heated at 50° C. for 24 hours. After 24 hours, the mixture was cooled to 0° C. using a salted ice bath and 5 mL of 1 M HCl was injected slowly. 5 mL of hexane was then injected into the round-bottom flask and stirred for an additional hour. After stirring, the organic layer was separated and analysed using GC-MS. As can be seen in the chromatograms in FIG. 21, there are five groups of peaks and an isolated peak at around 27.5 minutes. As the concentration of DCPD increased, the relative height of the peaks with lower retention time (lower molecular weight) decreased. The number of peaks also decreased in the higher DCPD samples and the chromatograms converged on several peaks.

### Example 7—Polymerisation of Molten Sulfur with a Gas

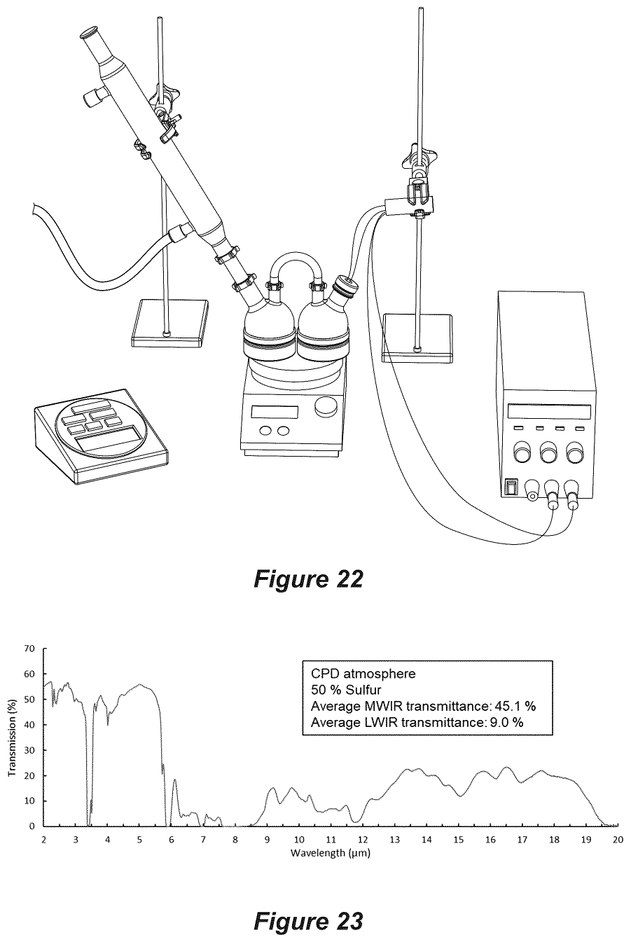

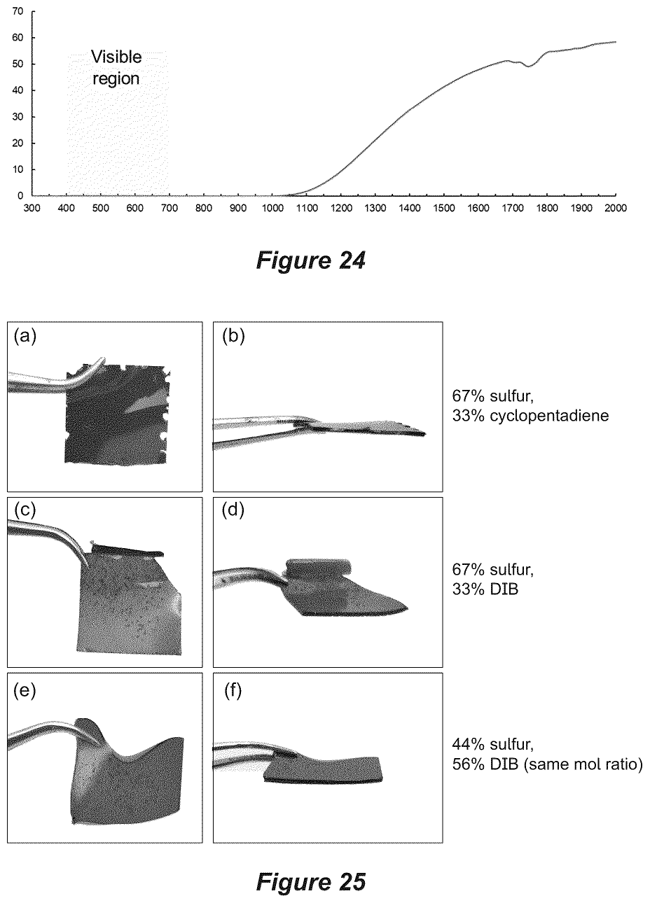

Two 2-neck, round-bottom flasks were connected with a glass tube and a water-cooled condenser was added to one of them (FIG. 22). Cyclopentadiene (3 g) was added to the round-bottom flask connected to the condenser, while sulfur (3 g) was added to the other. A rubber septum was placed over the opening of the round-bottom flask with sulfur. Through this seal, needles for a gas pump were passed into the round-bottom flask. The inlet needle was placed in the headspace of the round-bottom flask while the outlet needle was submerged in the sulfur. This pump was powered by a DC power supply to circulate the atmosphere through the sulfur at an approximate rate of 425 mL/minute. Both round-bottom flasks were heated to 140° C. with stirring provided by a magnetic stirrer bar. The temperature used in this reaction was below the boiling point of dicyclopentadiene (170° C.) but is far above the boiling temperature of cyclopentadiene (41° C.). Therefore, any dicyclopentadiene or other oligomers that are formed in the reflux of cyclopentadiene would remain in the round-bottom flask with the attached condenser and would not participate in the reaction with sulfur. Due to the much lower boiling point of cyclopentadiene, it passed through the glass tube into the round-bottom flask containing sulfur. In this round-bottom flask, the cyclopentadiene was constantly cycled through the sulfur until it underwent reaction with sulfur to form a polymer. The reaction was heated for 2.5 hours at 140° C. Over this time, the sulfur darkened to a very dark viscous polymer. The polymer was then transferred to a silicone mould and placed in a 140° C. oven for 24 hours to cure. The IR spectrum for a 1 mm thick sample of the polymer is shown in FIG. 23, with regions of transparency observable at wavelengths of 3 μm to 5 μm and 9 μm to 12 μm. FIG. 24 shows the visible and near-IR transmission spectrum for a 1 mm thick polymer sample made by the reaction of molten sulfur and cyclopentadiene gas. The low transmittance in the visible region is consistent with the black colour observed. IR transmission is observed from 1000 to 2000 cm⁻¹.

### Example 8—Comparison of Polymers of the Present Invention with Prior Art Polymers

a. Sulfur-DIB Polymers

A polymer made from sulfur and 1,3-diisopropenylbenzene (DIB) was prepared using the method outlined by Pyun (Pyun, J. et al (2014) ACS Macro Lett. 3 (3), 229-232), with only a slight modification to allow for appropriately-shaped polymer pieces for IR transmission testing. Two polymer compositions were prepared so they could be compared with the cyclopentadiene polymer prepared according to Example 2. The first polymer composition had the same mass ratio of sulfur to DIB (as sulfur to cyclopentadiene used in Example 2) while the second composition had the same molar ratio. A total mass of 5 g was used for both compositions. The first DIB polymer composition used 3.33 g of sulfur and 1.67 g of DIB while the second used 2.21 g of sulfur and 2.79 g of DIB.

Sulfur was added to a 21 mL scintillation vial with a magnetic stirring rod and added to an aluminium heating block at 185° C. The sulfur was left for 3 minutes over which time it became an orange liquid. DIB was then added by pipette to the molten sulfur and the reaction was left for an additional 8 minutes. Over this time, the mixture would change to a deep red viscous mixture as the sulfur reacted with DIB. In the original method described by Pyun, the reaction was left to vitrify, which happened after 9 to 11 minutes from when the DIB was added, depending on composition. This method was modified slightly to allow for 1 mm thick polymer windows to be produced. Instead of allowing the mixture to completely vitrify in the scintillation vial, it was transferred to a preheated silicone mould after 8 minutes and added to a 185° C. oven for an additional 3 minutes. After this time, the polymer was removed from the oven and allowed to cool to room temperature before removal from the mould.

The DIB-containing polymers had a deep red colour and were slightly transparent. The polymer with a higher sulfur content was soft and clearly had a glass transition below room temperature while the polymer with a greater proportion of DIB was brittle and glassy (see FIG. 25).

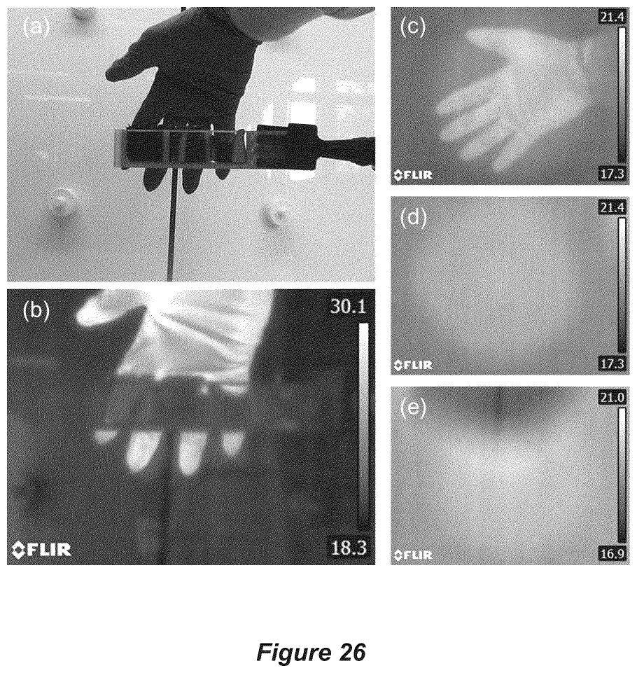

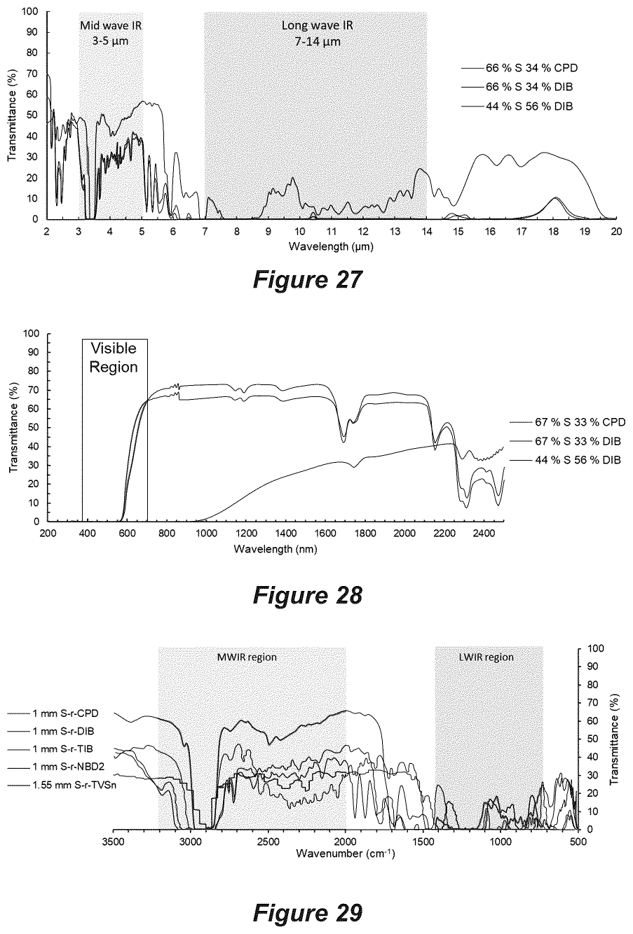

All polymer samples had the same thickness of 1 mm, allowing for direct comparison of IR transmission and imaging capabilities. All polymer samples were imaged using a LWIR camera, and tested for transmission from 300 nm to 20000 nm. FIG. 26 shows (a) the visual and (b) to (e) LWIR images through the sheets composed of cyclopentadiene and DIB polymers. Both compositions of DIB showed some transparency in the visible image, while the sheet composed of the cyclopentadiene polymer was completely opaque. However, the opposite was true in the LWIR images: the sheet composed of the cyclopentadiene polymer was transparent, while both sheets composed of DIB polymers showed no transparency in this region. These LWIR images clearly show that the cyclopentadiene polymer is more transparent in the LWIR region than the prior art polymers. This can also be seen from the IR spectra in the LWIR region (see FIG. 27). As can be seen from FIG. 27, both of the sheets composed of DIB polymers showed almost no transmittance in the LWIR region while the cyclopentadiene polymer showed some transmittance over most of the region.

The transmittance in the visible and near IR (NIR) regions for the cyclopentadiene polymer along with the two DIB polymers is shown in FIG. 28. Both of the sheets composed of DIB polymers showed excellent transmittance over almost all the NIR region but transmittance sharply decreased after 2100 nm. Both of the sheets composed of DIB polymers showed some transmittance in the visible region, particularly from 600 nm to 700 nm, which explains the red colour and transparency of these polymers.

b. Other High-Sulfur Polymers

Six polymer compositions were selected to compare with the polymer of Example 2 (S-r-CPD). Sulfur-based polymers containing the following monomers were selected due to their high transmittance in the LWIR region: 1,2-diisopropenylbenzene (DIB) (Pyun, J. et al (2014) ACS Macro Lett. 3 (3), 229-232); 1,3,5-triisopropenylbenzene (TIB) (Pyun, J. et al (2016) ACS Macro Lett. 5 (10), 1152-1156); norbornadiene 2 (NBD2) (Pyun, J. et al (2019) Angewandte Chemie International Edition 58 (49), 17656-17660); tetravinyltin (TVSn) (Boyd, D. A. et al (2019) ACS Macro Lett. 8 (2), 113-116); poly(phenylene polysulfide) networks produced through the polycondensation of p-diiodobenzene (PSN76) (Lee, J. M. et al (2019) ACS Macro Lett. 8 (8), 912-916); and the allyl derivative of 2,3-bis((2-mercaptoethyl)thio)-1-propanethiol (BMETP-TA) (Qiu, Y. et al (2021) Macromolecular Chemistry and Physics 222 (24), 2100311.

To accurately compare these polymers, factors such as thickness must be considered. While thickness of the selected polymers varied, most literature sources presented the IR transmission spectra for either a 1 mm or 200 μm thick sample. Samples of the cyclopentadiene polymer of the same thickness were prepared from the ratio of 67% sulfur/33% cyclopentadiene. A 1 mm thick sample was prepared using a silicone mould with a 1 mm thick glass slide as a negative. This same process was not appropriate for freestanding films at a thickness of 200 μm as the high viscosity of the prepolymer meant it did not flow into the extremely thin mould. This would result in an inconsistent thickness and bubbles in some cases. To overcome this issue, a different process was used. To produce the 200 μm thick window, a heated press was used to compress the polymer to the desired thickness. A 25×25 mm square was cut out of a 200 μm thick Teflon sheet. This was used to control the shape and thickness of the polymer window. 210 mg of cured polymer made from 67% sulfur/33% cyclopentadiene was ground into a powder and placed in this cut out section of the Teflon sheet. The sheet and polymer were then placed in a heated press and the press was heated to 140° C. After the temperature had reached 140° C. (approximately 15 mins), the polymer was compressed to 10 Mpa for 35 minutes. After this time, the sample was removed from the press and allowed to cool. Both the 1 mm and 200 μm thick polymer samples were tested for IR transmission between 2 μm and 20 μm using a Perkin Elmer Frontier FTIR.

To quantitatively compare the polymers from literature with the cyclopentadiene polymer of the present invention, the transmission data had to be extracted from the available literature figures. This was done through Matlab using a script which would display an image of a plot from literature. The data could then be extracted by clicking on the plot and calibrated to give the correct units by clicking on the origin and the maximum point on the x and y axis. After data extraction, the script would integrate over any regions of interest to get the average transmittance of the sample in the region. The MWIR (3 μm to 5 μm) and LWIR (7 μm to 14 μm) regions were used to compare samples.

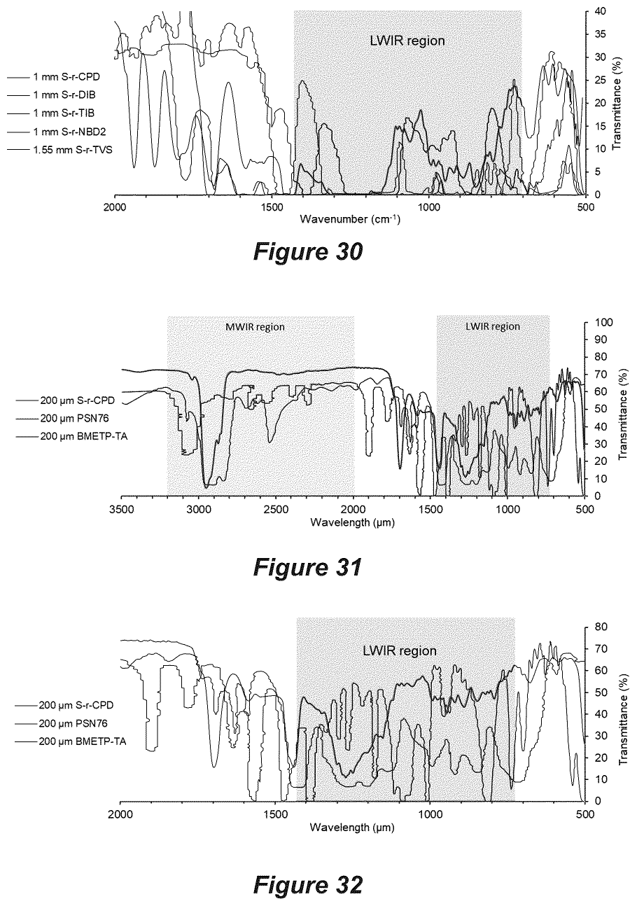

FIGS. 29 and 30 show the comparison of the S-r-CPD polymer with the polymers prepared with DIB, TIB, NBD2 and TVSn (referred to as S-r-DIB, S-r-TIB, S-r-NBD2 and S-r-TVSn, respectively). FIG. 29 shows the MWIR region as well as the LWIR region. As can be seen, S-r-CPD has greater transmittance over almost the entire MWIR region. The S-r-CPD polymer also has a greater transmittance than the S-r-DIB and S-r-TIB polymer over the entire LWIR region. The S-r-CPD polymer has a greater transmittance than the S-r-NBD2 over most of the LWIR region, however, the NBD2 polymer shows a large peak between 1430 cm⁻¹ and 1330 cm⁻¹. The S-r-TVSn polymer has similar transmittance over the LWIR region, however, it was difficult to get an accurate description of the transmittance as this sample had a greater thickness. FIG. 30 shows the same FTIR spectra but where the LWIR region has been expanded.

FIG. 31 shows the FTIR spectra for the 200 μm thick samples. These spectra show the S-r-CPD polymer along with the S-r-PSN76 and S-r-BMETP-TA polymers. Like the other samples, the S-r-CPD polymer shows a greater transmittance over almost the entire MWIR region. It also shows a greater transmittance than S-r-BMETP-TA over almost the entire LWIR region, while the S-r-PSN76 polymer shows greater transmittance in some areas of the LWIR region but has some areas with no transmittance, while the S-r-CPD polymer transmits over this entire region. FIG. 32 shows the same FTIR spectra but where the LWIR region has been expanded.

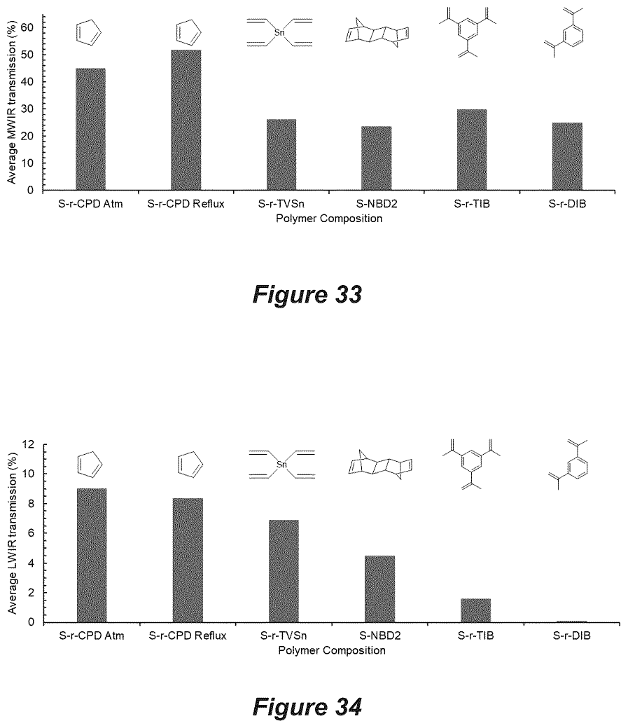

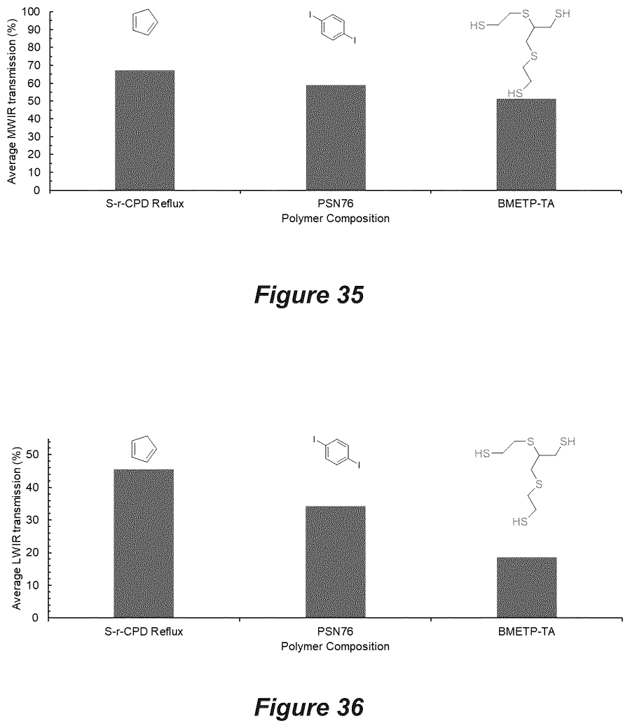

The transmittance for each polymer sample was integrated over the MWIR and LWIR regions and an average transmittance was calculated. As can be seen, the S-r-CPD polymer shows a much greater average transmittance in both the MWIR (FIG. 33) and LWIR (FIG. 34) region than any of the other 1 mm thick samples. However, it should be noted that the S-r-TVSn polymer was 1.55 mm thick so an accurate comparison cannot be made. The S-r-CPD polymer also shows the greatest transmission in both the MWIR and LWIR regions for the 200 μm samples (see FIGS. 35 and 36).

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

1. (canceled)

2. (canceled)

3. (canceled)

4. (canceled)

5. (canceled)

6. (canceled)

7. (canceled)

8. A cured polymer having a sulfur content of between about 40% w/w and about 90% w/w and a monomer content of between about 60% w/w and about 10% w/w, wherein the monomer is a low molecular weight, rigid, organic monomer, and wherein the polymer is transparent to mid-wave infrared (MWIR) light and long-wave infrared (LWIR) light.

9. The cured polymer of claim 8, wherein an additional co-monomer is also present.

10. The cured polymer of claim 8, wherein the monomer is selected from the group consisting of ethene, acetylene, tetrafluoroethylene, tetrachloroethylene, propene, butadiene, carbondisulfide, and cyclopentadiene, cyclopropene, cyclobutene, cyclobutadiene, and episulfide.

11. The cured polymer of claim 9, wherein the additional co-monomer is a low molecular weight, rigid, unsaturated organic monomer.

12. The cured polymer of claim 11, wherein the additional co-monomer is selected from the group consisting of ethene, acetylene, tetrafluoroethylene, tetrachloroethylene, propene, butadiene, carbondisulfide, cyclopentadiene, dicyclopentadiene, norbornene, and norbornadiene, cyclopropene, cyclobutene, cyclobutadiene, and episulfide.

13. The cured polymer of claim 8, having a % transmittance of MWIR light of greater than or equal to about 50% at a thickness of about 1 mm.

14. The cured polymer of claim 8, having a % transmittance of LWIR light of greater than or equal to about 8% at a thickness of about 1 mm.

15. The cured polymer of claim 8, having a % transmittance of visible light of less than or equal to 0% at a thickness of about 1 mm.

16. A component for use in infrared (IR) imaging applications, the component composed of, or comprising, the cured polymer of claim 1.

17. (canceled)

18. (canceled)

19. (canceled)

20. (canceled)

21. (canceled)

22. (canceled)

23. A method of producing a cured polymer that is transparent to mid-wave infrared (MWIR) light and long-wave infrared (LWIR) light, the method comprising:
a) providing molten elemental sulfur;
b) adding, to the molten elemental sulfur, low molecular weight, rigid, organic monomers in aliquots to produce a mixture, wherein the aliquots are added such that the sulfur does not crystallise;
c) optionally further heating the mixture;
thereby preparing a polymer, and
d) curing the prepared polymer.

24. The method of claim 23, wherein the molten elemental sulfur is heated at a temperature of between about 140° C. and about 185° C.

25. The method of claim 23, wherein the monomers are added to the elemental sulfur in a total amount of from about 1:1 to about 1:4 (weight ratio) of monomers to elemental sulfur.

26. The method of claim 23, wherein the monomers are in a gaseous state.

27. The method of claim 26, wherein the monomers are introduced directly into the molten elemental sulfur.

28. The method of claim 23, wherein the monomers are selected from the group consisting of ethene, acetylene, tetrafluoroethylene, tetrachloroethylene, propene, butadiene, carbondisulfide, cyclopentadiene, cyclopropene, cyclobutene, cyclobutadiene, and episulfide.

29. The method of claim 23, wherein an additional co-monomer is also added to the molten elemental sulfur.

30. The method of claim 29, wherein the additional co-monomer is a low molecular weight, rigid, organic monomer.

31. The method of claim 30, wherein the additional co-monomer is selected from the group consisting of ethene, acetylene, tetrafluoroethylene, tetrachloroethylene, propene, butadiene, carbondisulfide, cyclopentadiene, dicyclopentadiene, norbornene, norbornadiene, cyclopropene, cyclobutene, cyclobutadiene, and episulfide.

32. The method of claim 29, wherein the additional co-monomer is added to the elemental sulfur in a total amount of from about 1:10 to about 1:1 (weight ratio) of elemental sulfur to co-monomer.

33. The method of claim 29, wherein the molten elemental sulfur is heated at a temperature of between about 160° C. and about 185° C.

34. An apparatus for polymerising molten elemental sulfur with monomers in a gaseous state, the apparatus comprising a first sealed vessel, the first sealed vessel comprising:
molten elemental sulfur;
a port through which monomers in a gaseous state are introduced into the first sealed vessel, such that the monomers reside in the headspace above the molten elemental sulfur;
an outlet through which the monomers are introduced directly into the molten elemental sulfur;
an inlet in fluid communication with both the outlet and with the headspace above the molten elemental sulfur,
wherein the monomers are continuously circulated from the headspace through the inlet and out of the outlet into the molten elemental sulfur such that the monomers undergo a polymerisation reaction with the molten elemental sulfur.

35. (canceled)

36. (canceled)

37. (canceled)

38. (canceled)

39. (canceled)

40. (canceled)
